(19) United States
(12) Patent Application Publication
(10) Pub. No.: US 2022/0245735 A1
(43) Pub. Date: Aug. 4, 2022

(54) INFORMATION PROCESSING APPARATUS, INFORMATION PROCESSING METHOD, AND COMPUTER READABLE MEDIUM

(71) Applicant: MITSUBISHI ELECTRIC CORPORATION, Tokyo (JP)

(72) Inventor: Takaomi SATO, Tokyo (JP)

(73) Assignee: MITSUBISHI ELECTRIC CORPORATION, Tokyo (JP)

(21) Appl. No.: 17/727,314

(22) Filed: Apr. 22, 2022

Related U.S. Application Data
(63) Continuation of application No. PCT/JP2020/029273, filed on Jul. 30, 2020.

(30) Foreign Application Priority Data
Dec. 18, 2019 (JP) PCT/JP2019/049593

(51) Int. Cl. G06Q 50/04; G06Q 10/06

(52) U.S. Cl. CPC G06Q 50/04; G06Q 10/06312

(57) ABSTRACT

A necessary resource amount calculation unit (410) specifies based on a production plan, a plurality of resources used for realizing the production plan, and calculates as a necessary resource amount, an amount of each resource necessary for realizing the production plan. A cost calculation unit (415) calculates for each resource specified by the necessary resource amount calculation unit (410), a cost for acquiring the necessary resource amount. A production evaluation index calculation unit (416) assigns according to a purpose of each resource specified by the necessary resource amount calculation unit (410), each resource to a purpose category among a plurality of purpose categories each of which is a category of a purpose, and aggregates for each purpose category, the cost of the resource assigned to each purpose category.

### CROSS REFERENCE TO RELATED APPLICATIONS

This application is a Continuation of PCT International Application No. PCT/JP2020/029273, filed on Jul. 30, 2020, which claims priority under 35 U.S.C. 119(a) to Patent Application No. PCT/JP2019/049593, filed in the Japan on Dec. 18, 2019, all of which are hereby expressly incorporated by reference into the present application.

### TECHNICAL FIELD

The present invention relates to evaluation of a production plan.

### BACKGROUND ART

Conventionally, in a manufacturing industry, low-variety and high-volume production has been mainly practiced, and there has been a situation where demand from end users has exceeded supply. Therefore, conventionally, in the manufacturing industry, production efficiency has been emphasized, and other indexes such as energy efficiency and an environmental burden amount have been considered separately from productivity. However, in recent years, depletion of resources, environmental pollution, and the like are large problems, and furthermore, in the manufacturing industry, not only the productivity but also reduction in the usage amount of materials, reduction in the usage amount of energy resources, and reduction in an environmental burden are demanded.

In Patent Literature 1, a system is disclosed which evaluates production in addition to the productivity, including other indexes related to the production. More specifically, in Patent Literature 1, the system is disclosed which is capable of calculating and evaluating added value in production steps such as production efficiency together with an environmental burden occurred in the production steps.

### CITATION LIST

### Patent Literature

Patent Literature 1: JP2006-221573A

### SUMMARY OF INVENTION

### Technical Problem

In order to establish a production plan from a perspective of management, an aspect of cost cannot be ignored in addition to an environmental burden occurred in production steps, production efficiency, and the like.

According to the technique of Patent Literature 1, it is possible to calculate influence on the environmental burden, the production efficiency, and the like, the influence being caused by changing the production plan. However, there is a problem that influence by a change of the production plan on cost is unknown.

The present invention mainly aims to solve such a problem. More specifically, the present invention mainly aims to calculate for each purpose, a cost required for realizing a production plan.

### Solution to Problem

An information processing apparatus according to the present invention includes:

a necessary resource amount calculation unit to specify based on a production plan, a plurality of resources used for realizing the production plan, and calculate as a necessary resource amount, an amount of each resource necessary for realizing the production plan;

a cost calculation unit to calculate for each resource specified by the necessary resource amount calculation unit, a cost for acquiring the necessary resource amount; and

a category aggregation unit to assign according to a purpose of each resource specified by the necessary resource amount calculation unit, each resource to a purpose category among a plurality of purpose categories each of which is a category of a purpose, and aggregate for each purpose category, the cost of the resource assigned to each purpose category.

### Advantageous Effects of Invention

According to the present invention, it is possible to evaluate for each purpose, a cost required for realizing a production plan.

### BRIEF DESCRIPTION OF DRAWINGS

FIG. 1 is a diagram illustrating a configuration example of a production plan optimization system according to a first embodiment.

FIG. 2 is a diagram illustrating a hardware configuration example of a production plan optimization apparatus according to the first embodiment.

FIG. 3 is a diagram illustrating a functional configuration example of the production plan optimization apparatus according to the first embodiment.

FIG. 4 is a diagram illustrating an example of step information according to the first embodiment.

FIG. 5 is a diagram illustrating a production step according to the first embodiment.

FIG. 6 is a diagram illustrating an example of productivity information according to the first embodiment.

FIG. 7 is a diagram illustrating an example of step operation information according to the first embodiment.

FIG. 8 is a diagram illustrating an example of equipment operation information according to the first embodiment.

FIG. 9 is a diagram illustrating an example of production plan information according to the first embodiment.

FIG. 10 is a diagram illustrating an example of calculation time information according to the first embodiment.

FIG. 11 is a diagram illustrating an example of calculation unit-time information according to the first embodiment.

FIG. 12 is a diagram illustrating an example of production resource information according to the first embodiment.

FIG. 13 is a diagram illustrating an example of the production resource information according to the first embodiment.

FIG. 14 is a diagram illustrating an example of the production resource information according to the first embodiment.

FIG. 15 is a diagram illustrating an example of environmental burden information according to the first embodiment.

FIG. 16 is a diagram illustrating an example of the environmental burden information according to the first embodiment.

FIG. 17 is a diagram illustrating an example of the environmental burden information according to the first embodiment.

FIG. 18 is a diagram illustrating an example of inventory management information according to the first embodiment.

FIG. 19 is a diagram illustrating an example of production equipment operation status information according to the first embodiment.

FIG. 20 is a diagram illustrating an example of supply equipment operation plan information according to the first embodiment.

FIG. 21 is a diagram illustrating an example of supply resource information according to the first embodiment.

FIG. 22 is a diagram illustrating an example of supply equipment operation status information according to the first embodiment.

FIG. 23 is a diagram illustrating an example of necessary resource amount information according to the first embodiment.

FIG. 24 is a diagram illustrating an example of cost item information according to the first embodiment.

FIG. 25 is a diagram illustrating an example of cost information according to the first embodiment.

FIG. 26 is a diagram illustrating an example of production evaluation index information according to the first embodiment.

FIG. 27 is a flowchart illustrating an operation example of the production plan optimization apparatus according to the first embodiment.

FIG. 28 is a diagram illustrating a functional configuration example of a production plan optimization apparatus according to a second embodiment.

FIG. 29 is a diagram illustrating an example of production evaluation index target information according to the second embodiment.

FIG. 30 is a diagram illustrating an example of production plan information which is after change according to the second embodiment.

FIG. 31 is a diagram illustrating an example of changed production plan information according to the second embodiment.

FIG. 32 is a diagram illustrating an example of changed production evaluation index information according to the second embodiment.

FIG. 33 is a diagram illustrating an example of the changed production evaluation index information according to the second embodiment.

FIG. 34 is a flowchart illustrating an operation example of the production plan optimization apparatus according to the second embodiment.

FIG. 35 is a diagram illustrating a functional configuration example of a production plan optimization apparatus according to a third embodiment.

FIG. 36 is a diagram illustrating a functional configuration example of a production plan optimization apparatus according to a fourth embodiment.

FIG. 37 is a diagram illustrating an example of regulation value information according to the fourth embodiment.

FIG. 38 is a diagram illustrating an example of a CO2 emission amount and an electricity consumption amount according to the fourth embodiment.

FIG. 39 is a flowchart illustrating an operation example of the production plan optimization apparatus according to the fourth embodiment.

FIG. 40 is a flowchart illustrating an operation example of the production plan optimization apparatus according to the fourth embodiment.

FIG. 41 is a diagram illustrating an example of the production evaluation index information according to the first embodiment.

FIG. 42 is a diagram illustrating an example of the production evaluation index target information according to the second embodiment.

FIG. 43 is a diagram illustrating an example of the changed production evaluation index information according to the second embodiment.

FIG. 44 is a diagram illustrating an example of the changed production evaluation index information according to the second embodiment.

### DESCRIPTION OF EMBODIMENTS

Hereinafter, embodiments of the present invention will be described with reference to the drawings. In the following description of the embodiments and the drawings, parts assigned by the same reference numerals indicate the same parts or corresponding parts. In the following drawings, values whose first decimal places are rounded are indicated.

### First Embodiment

### *** Description of Configuration ***

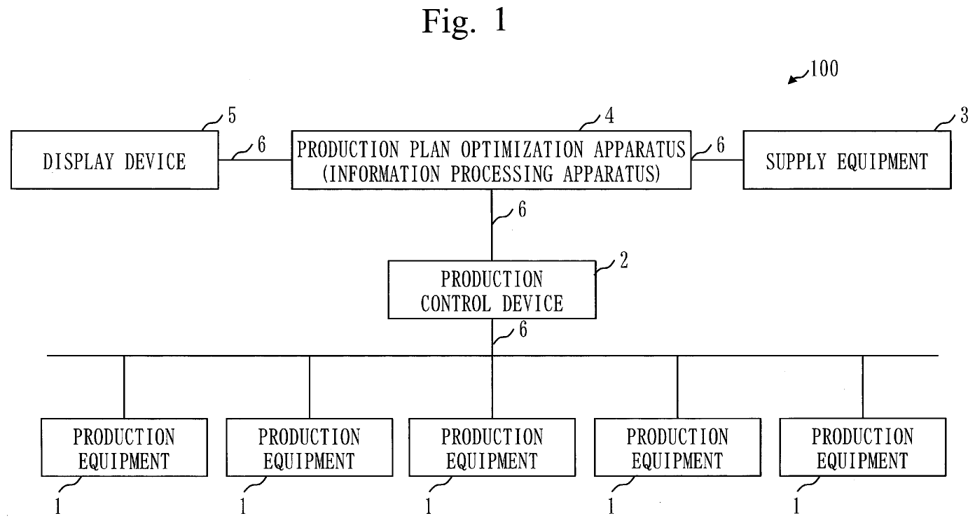

FIG. 1 illustrates an example of a production plan optimization system 100 according to a first embodiment.

As illustrated in FIG. 1, the production plan optimization system 100 includes five pieces of production equipment 1, a production control device 2, supply equipment 3, a production plan optimization apparatus 4, a display device 5, and a network 6. Note that, in the present embodiment, an example will be described in which the production plan optimization system 100 includes five pieces of production equipment 1, however, the amount of production equipment 1 may be any amount.

Further, in the present embodiment, an example will be described in which the production plan optimization system 100 includes one piece of supply equipment 3; however, any number is acceptable for the number of pieces of supply equipment 3.

The production equipment 1 is equipment used for producing products.

The production equipment 1 is, for example, an injection molding machine and an extrusion molding machine that alter raw materials of the products. Further, the production equipment 1 may include altering devices such as a lathe and a grinding machine. Further, the production equipment 1 may include an assembling device that assembles the products by tightening parts such as screws and nuts to the products, or doing others. Further, the production equipment 1 may include inspection devices such as a magnetic particle testing device, a radiographic testing device, and a penetrant testing device.

The production control device 2 controls the production equipment 1 according to production plan information which is information regarding a production plan of the products, and manages production of the products.

The production control device 2 is, for example, Programmable Logic Controller (PLC) or the like. Note that, the production control device 2 acquires the production plan information from the production plan optimization apparatus 4. Details of the production plan information will be described later.

The supply equipment 3 is equipment that supplies a resource to the production equipment 1.

The resource that the supply equipment 3 supplies to the production equipment 1 is, for example, cold water, hot water, compressed air, electricity, or the like.

The supply equipment 3 generates supply equipment information regarding the supply equipment 3, and outputs the generated supply equipment information to the production plan optimization apparatus 4. Note that, details of the supply equipment information will be described later.

Further, the production equipment 1 and the supply equipment 3 are connected via a supply path, not illustrated, which is for supplying the resource, such as a water supply pipe, an air pipe, or an electric line. Note that, the supply equipment 3 is equipment that cannot be controlled by the production control device 2. Further, a manager who manages the production equipment 1 and a manager who manages the supply equipment 3 can be different from each other. Further, the supply equipment 3 is equipment that supplies the resource to only the production equipment 1 that the production control device 2 controls. The supply equipment 3 does not supply the resource to the production equipment 1 that the production control device 2 does not control.

The production plan optimization apparatus 4 has various types of information regarding the production plan. The production plan optimization apparatus 4 acquires the supply equipment information from the supply equipment 3. The production plan optimization apparatus 4 generates the production plan information of the products based on the acquired supply equipment information and production equipment information regarding the production equipment 1.

Further, the production plan optimization apparatus 4 outputs the generated production plan information to the production control device 2 and the display device 5. Note that, details of a generation method of the production plan for the production plan optimization apparatus 4 and the production plan information will be described later.

The production plan optimization apparatus 4 is equivalent to an information processing apparatus. Further, an operation procedure of the production plan optimization apparatus 4 is equivalent to an information processing method. Further, a program that realizes operation of the production plan optimization apparatus 4 is equivalent to an information processing program.

The display device 5 generates a display screen based on the production plan information acquired from the production plan optimization apparatus 4, and displays the generated display screen. The display device 5 includes a monitor such as a liquid crystal display or an organic EL display. The display device 5 displays the generated display screen on the monitor.

Note that, in the present embodiment, an example will be described in which the display device 5 and the production plan optimization apparatus 4 are separated from each other, however, the display device 5 may be integrated with the production plan optimization apparatus 4. That is, the production plan optimization apparatus 4 may have a display function.

The network 6 is a network that connects the production equipment 1 and the production control device 2, the production control device 2 and the production plan optimization apparatus 4, the supply equipment 3 and the production plan optimization apparatus 4, and the production plan optimization apparatus 4 and the display device 5. The network 6 is, for example, a field network such as CC-Link (Control & Communication Link, registered trademark). Further, the network 6 may be a general network such as Ethernet (registered trademark), or a dedicated input/output line.

Note that, in the present embodiment, an example will be described of connections between the production equipment 1 and the production control device 2, the production control device 2 and the production plan optimization apparatus 4, the supply equipment 3 and the production plan optimization apparatus 4, and the production plan optimization apparatus 4 and the display device 5, via all the same networks 6. However, each one may be connected via different networks.

Next, details of the production plan optimization apparatus 4 will be described.

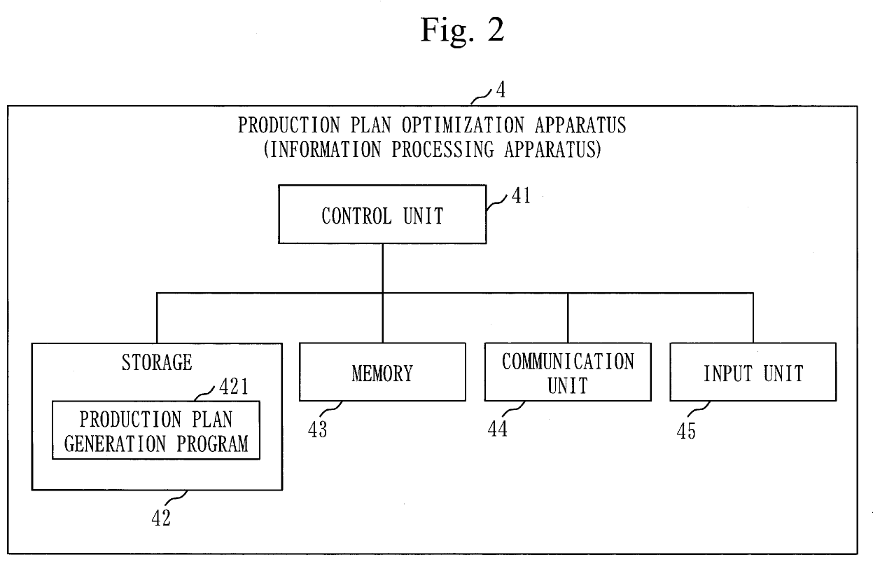

FIG. 2 illustrates a hardware configuration example of the production plan optimization apparatus 4 according to the first embodiment.

As illustrated in FIG. 2, the production plan optimization apparatus 4 includes a control unit 41, a storage 42, a memory 43, a communication unit 44, and an input unit 45. Note that, the production plan optimization apparatus 4 includes a power supply, not illustrated, which is a power source.

The control unit 41 controls the production plan optimization apparatus 4.

The control unit 41 may be a processor such as a CPU (Central Processing Unit). Also, the control unit 41 may be an integrated circuit such as an FPGA (Field Programmable Gate Array), an LSI (Large Scale Integration), or an ASIC (Application Specific Integrated Circuit). Also, the control unit 41 may be a combination of the processor and the integrated circuit.

Note that, the control unit 41 which is a superordinate concept of the processor and the integrated circuit can be referred to as “processing circuitry”.

In the present embodiment, an example will be described in which the control unit 41 is the processor that executes a program. That is, the control unit 41 executes a production plan generation program 421 which is stored in the storage 42. Details of the production plan generation program 421 will be described later.

The control unit 41 controls the storage 42, the memory 43, the communication unit 44, and the input unit 45, executes the production plan generation program 421, and generates the production plan information based on the supply equipment information acquired from the supply equipment 3 and the production equipment information of the production equipment 1. Further, the control unit 41 executes the production plan generation program 421, and generates necessary resource amount information, cost information, and the like which will be described later.

The storage 42 stores various types of programs executed by the control unit 41, data referred to by the control unit 41 when the control unit 41 executes the various types of programs, data generated by the control unit 41 as a result of execution of each program by the control unit 41, and the like.

The storage 42 stores, for example, the production plan generation program 421.

The storage 42 is, for example, a non-volatile memory such as a flash memory, a ROM (Read Only Memory), a hard disk, a solid-state drive, or a memory card reader/writer.

The memory 43 is a storage device that the control unit 41 directly accesses at a time of executing a process of the program. Various types of programs and data which are stored in the storage 42 are copied to and temporally stored in the memory 43.

The memory 43 is, for example, a volatile memory such as a RAM (Random Access Memory).

Note that, the control unit 41 temporally stores in the memory 43, the program which has been usually stored in the storage 42, and executes the program by reading the program from the memory 43.

The communication unit 44 includes a receiver that receives data and a transmitter that transmits data.

The communication unit 44 performs communication with outside device, using the receiver and the transmitter.

The control unit 41 acquires the supply equipment information from the supply equipment 3 via the communication unit 44. Further, the control unit 41 outputs the production plan information of the products to the production control device 2 and the display device 5 via the communication unit 44.

The input unit 45 is a device that receives input from a user. The input unit 45 is, for example, a keyboard, a mouse, a touch pad, or a touch panel that has a display function.

Next, a functional configuration example of the production plan optimization apparatus 4 according to the present embodiment will be described.

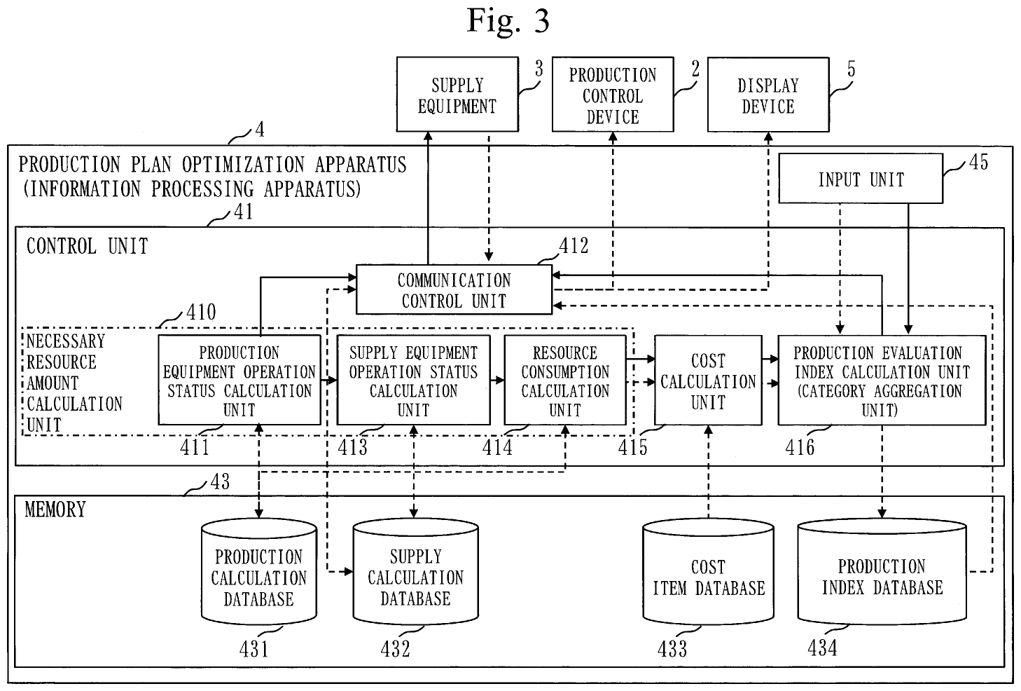

FIG. 3 illustrates the functional configuration example of the production plan optimization apparatus 4.

FIG. 3 schematically illustrates a state where the control unit 41 executes the production plan generation program 421.

The production plan generation program 421 includes a program that realizes a function of each of a production equipment operation status calculation unit 411, a communication control unit 412, a supply equipment operation status calculation unit 413, a resource consumption calculation unit 414, a cost calculation unit 415, and a production evaluation index calculation unit 416.

Below, for a reason of simplification, execution by the control unit 41, of a program that realizes a function of each of the production equipment operation status calculation unit 411, the communication control unit 412, the supply equipment operation status calculation unit 413, the resource consumption calculation unit 414, the cost calculation unit 415, and the production evaluation index calculation unit 416 will be described as operation of the production equipment operation status calculation unit 411, the communication control unit 412, the supply equipment operation status calculation unit 413, the resource consumption calculation unit 414, the cost calculation unit 415, and the production evaluation index calculation unit 416.

For example, below, executing the program that realizes the production equipment operation status calculation unit 411 by the control unit 41 and calculating production equipment operation status by the control unit 41 will be described as calculating the production equipment operation status by the production equipment operation status calculation unit 411.

Further, for easier understanding, FIG. 3 also illustrates the memory 43, the input unit 45, the production control device 2, the supply equipment 3, and the display device 5.

The memory 43 stores a production calculation database 431, a supply calculation database 432, a cost item database 433, and a production index database 434.

The production calculation database 431 is a database which can be acquired by temporally copying a database stored in the storage 42.

The supply calculation database 432 is a database generated when the control unit 41 executes the production plan generation program 421.

The cost item database 433 is a database used for generating cost information which will be described later.

The production index database 434 is a database that stores production evaluation index information and an evaluation value which will be described later.

In FIG. 3, a flow of a process of each functional block is indicated by a solid arrow. Further, a flow of data between functional blocks is indicated by a dashed arrow.

Note that, the production calculation database 431 and the supply calculation database 432 are periodically copied to the storage 42, and stored in the storage 42.

The production equipment operation status calculation unit 411, the supply equipment operation status calculation unit 413, and the resource consumption calculation unit 414 are collectively referred to as a necessary resource amount calculation unit 410.

Before details of each of the production equipment operation status calculation unit 411, the supply equipment operation status calculation unit 413, and the resource consumption calculation unit 414 are described, for easier understanding, an outline of operation of the production equipment operation status calculation unit 411, the supply equipment operation status calculation unit 413, and the resource consumption calculation unit 414 will be described below as operation of the necessary resource amount calculation unit 410. Note that, a process performed by the necessary resource amount calculation unit 410 is equivalent to a necessary resource amount calculation process.

Further, below, an outline of operation of the cost calculation unit 415 and the production evaluation index calculation unit 416 will also be described.

The necessary resource amount calculation unit 410 specifies a plurality of resources used for realizing the production plan. Then, the necessary resource amount calculation unit 410 calculates as a necessary resource amount, the amount of each resource necessary for realizing the production plan. The production plan includes a plurality of production steps. Therefore, the necessary resource amount calculation unit 410 specifies for each production step, resources necessary for realizing each production step, and calculates the necessary resource amount of specified resources.

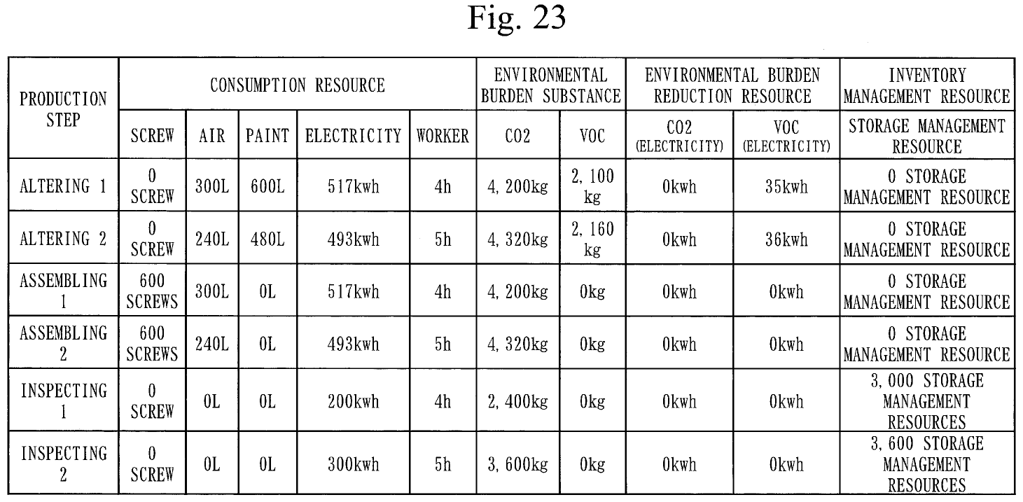

FIG. 23 illustrates an example of the necessary resource amount information. In the necessary resource amount information of FIG. 23, the necessary resource amount calculated by the necessary resource amount calculation unit 410 is indicated for each production step.

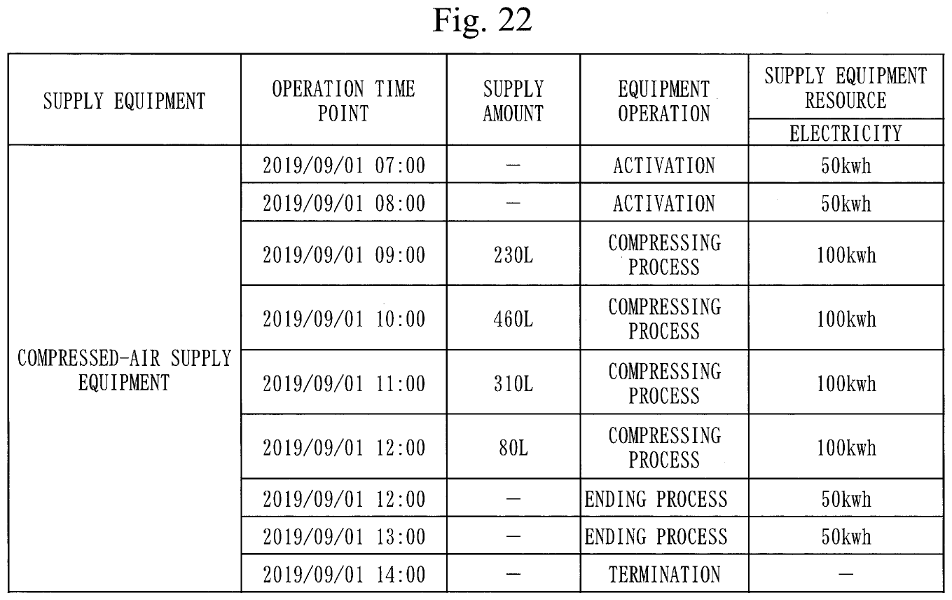

Details of FIG. 23 will be described later. In the necessary resource amount information of FIG. 23, a consumption resource, an environmental burden reduction resource, and an inventory management resource are indicated as the resources used for realizing the production plan. The consumption resource is a resource consumed in the production. The consumption resource includes, for example, a material used for the production. The environmental burden reduction resource is a resource used for reducing environmental burden generated in the production. The environmental burden reduction resource includes, for example, electricity for reducing VOC (Volatile Organic Compounds) gas (hereinafter, also simply referred to as “VOC”) generated in the production. Note that, in the necessary resource amount information of FIG. 23, the amount of environmental burden substances reduced by the environmental burden reduction resource is also indicated. The inventory management resource is a resource used for inventory management of the products. The supply equipment resource (FIG. 22) is a resource consumed for supply of the consumption resource in the supply equipment which supplies the consumption resource.

In FIG. 23, “600 screws” and the like indicated in a column of the consumption resource are the necessary resource amounts of consumption resources. Further, “4200 kg” and the like indicated in a column of the environmental burden reduction resource is the necessary resource amount of environmental burden reduction resources. Further, “3000 storage management resources” and the like indicated in a column of the inventory management resource is the necessary resource amount of inventory management resources.

The cost calculation unit 415 calculates for each resource specified by the necessary resource amount calculation unit 410, a cost for acquiring the necessary resource amount. As described above, since the necessary resource amount calculation unit 410 calculates the necessary resource amount for each production step, the cost calculation unit 415 calculates for each production step, the cost for acquiring the necessary resource amount.

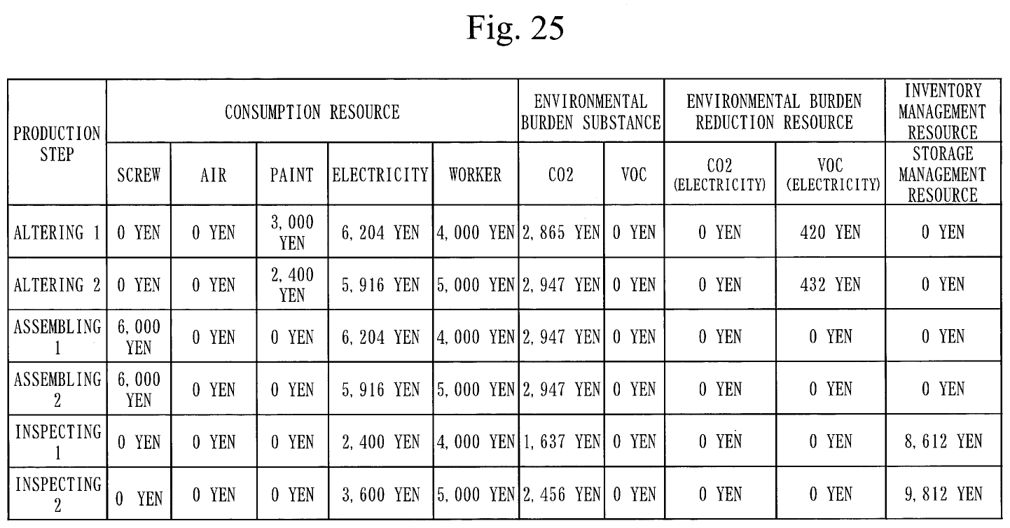

FIG. 25 illustrates an example of the cost information. The cost information indicates for each production step, the costs calculated by the cost calculation unit 415. Details of FIG. 25 will be described later. In the cost information, as with the necessary resource amount information of FIG. 23, the consumption resource, the environmental burden reduction resource, and the inventory management resource are indicated. In FIG. 25, “6000 yen” indicated in the column of the consumption resource, “420 yen” indicated in the column of the environmental burden reduction resource, “8612 yen” indicated in the column of the inventory management resource, and the like are the costs.

The production evaluation index calculation unit 416 calculates a production evaluation index. More specifically, the production evaluation index calculation unit 416 assigns for each production step, each resource to a purpose category among a plurality of purpose categories according to a purpose of each resource specified by the necessary resource amount calculation unit 410. Then, the production evaluation index calculation unit 416 aggregates the costs of the resources, for each production step and each purpose category. Further, the production evaluation index calculation unit 416 indexes an aggregation result of the costs of the plurality of purpose categories of the plurality of production steps. The aggregation result of the costs indexed by the production evaluation index calculation unit 416 is referred to as the production evaluation index.

The purpose category is a category provided for each of purposes of resources.

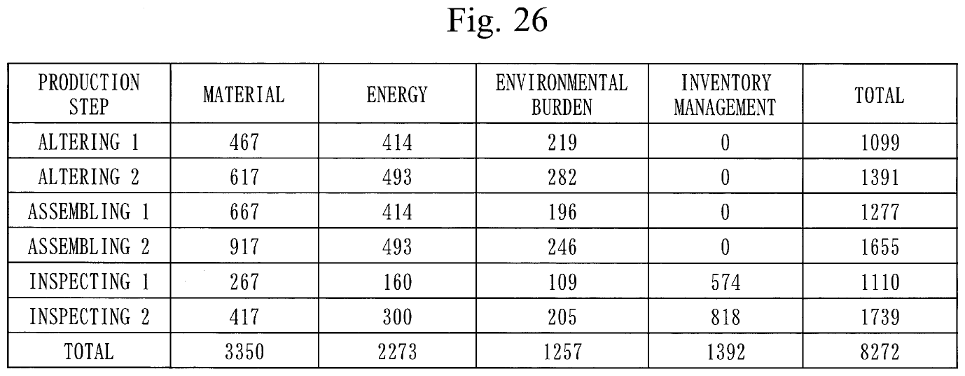

FIG. 26 illustrates an example of the production evaluation index information. Details of FIG. 26 will be described later. In the production evaluation index information of FIG. 26, there are a material category, an energy category, an environmental burden category, and an inventory management category as the purpose categories.

The material category is a category of resources which are used as materials among the resources. As the resources included in the material category, there are, for example, materials and human resources (for example, labor of a worker) which are used for the production. The index values indicated in the material category are used as index values regarding the productivity.

The energy category is a category of resources which are used as energy for producing the products among the resources. As the resources included in the energy category, there are electricity and gas for running a machine tool, and the like. The index values indicated in the energy category are used as index values regarding energy efficiency.

The environmental burden category is a category of resources which are used for reducing the environmental burden. As the resource included in the environmental burden category, there is electricity for reducing the VOC gas.

The inventory management category is a category of resources which are used for managing inventory of the products.

The production evaluation index information of FIG. 26 indicates the index values which are the indexed aggregation result of the costs, for each production step and each purpose category. Each of “467”, “414”, “219”, and the like indicated in FIG. 26 is the index value.

Further, the production evaluation index calculation unit 416 calculates the evaluation value of the production plan, using the index values of each purpose category and weight coefficients of each purpose category. The production evaluation index calculation unit 416 acquires the weight coefficients via the input unit 45.

Then, the production evaluation index calculation unit 416 outputs to the display device 5 and the production control device 2 via the communication control unit 412, the calculated evaluation value and the production evaluation index information which is indicated in FIG. 26. The communication control unit 412 controls communication.

Further, the production evaluation index calculation unit 416 stores in the production index database 434, the calculated evaluation value and the production evaluation index information which is indicated in FIG. 26.

The production evaluation index calculation unit 416 is equivalent to a category aggregation unit. Further, a process performed by the production evaluation index calculation unit 416 is equivalent to a category aggregation process.

Next, descriptions will be given on details of components of the production plan optimization apparatus 4, including the production equipment operation status calculation unit 411, the supply equipment operation status calculation unit 413, and the resource consumption calculation unit 414.

The production equipment operation status calculation unit 411 calculates the production equipment operation status.

The production equipment operation status calculation unit 411 acquires from the production calculation database 431 stored in the memory 43, the production equipment information regarding the production equipment 1. Then, the production equipment operation status calculation unit 411 calculates based on the acquired production equipment information, the production equipment operation status which indicates operation status of the production equipment 1. In the calculation of the production equipment operation status, the production equipment operation status calculation unit 411 specifies a plurality of resources used for realizing the production plan. Then, the production equipment operation status calculation unit 411 generates production equipment operation status information which indicates the production equipment operation status.

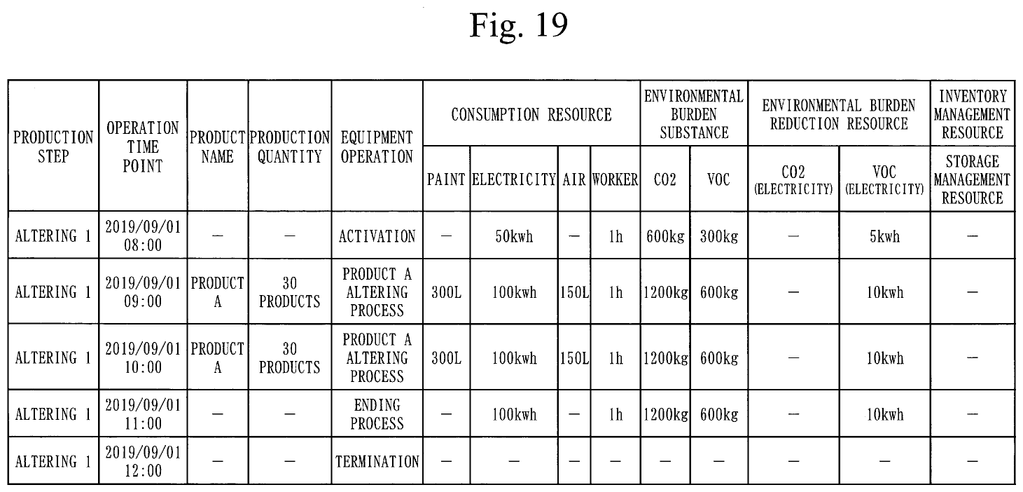

FIG. 19 illustrates an example of the production equipment operation status information. The production equipment operation status information indicates the resources used for realizing the production plan. The example of FIG. 19 indicates that paint, electricity, air, and a worker (labor) are necessary as the consumption resources. Further, the example of FIG. 19 indicates that electricity is necessary as the environment burden reduction resource in order to reduce the VOC gas. Further, the example of FIG. 19 indicates that a storage management resource is necessary as the inventory management resource.

Further, the production equipment information acquired from the production calculation database 431 is constituted by step information, productivity information, step operation information, equipment operation information, the production plan information, calculation time information, calculation unit-time information, production resource information, environmental burden information, and inventory management information.

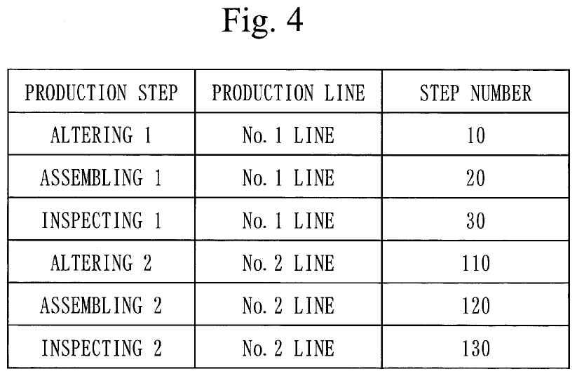

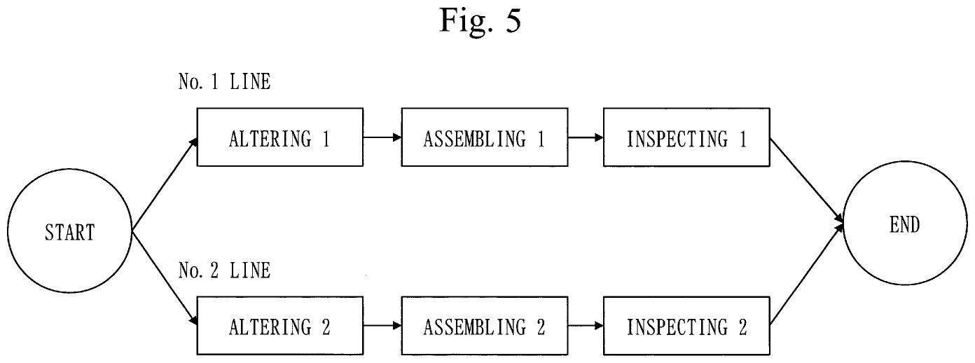

The step information indicates the production step in which the products are produced. FIG. 4 illustrates an example of the step information. The step information of FIG. 4 indicates the production steps of FIG. 5. Details of FIGS. 4 and 5 will be described later.

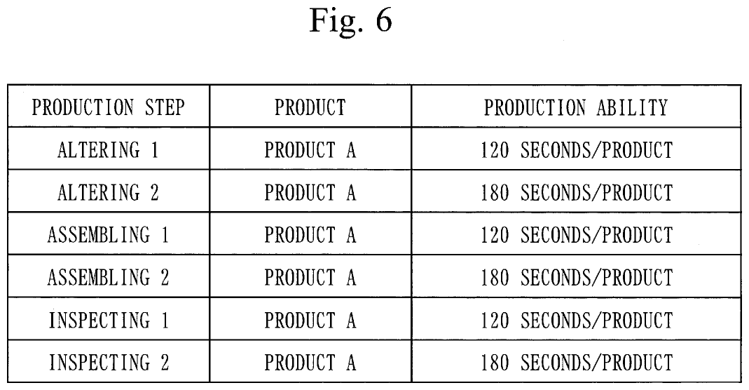

The productivity information indicates production time per one product in each production step. FIG. 6 indicates an example of the productivity information. Details of FIG. 6 will be described later.

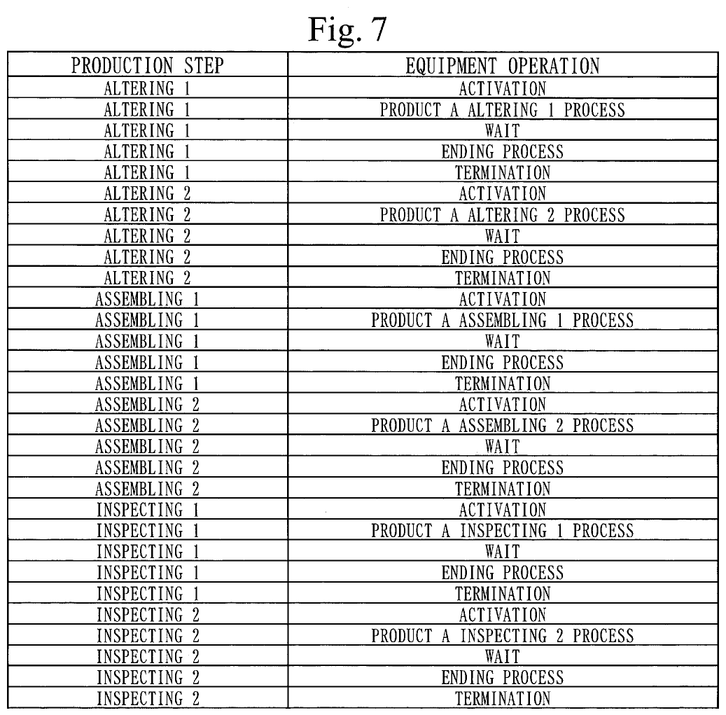

The step operation information indicates equipment operation that each production step has. FIG. 7 indicates an example of the step operation information. Details of FIG. 7 will be described later.

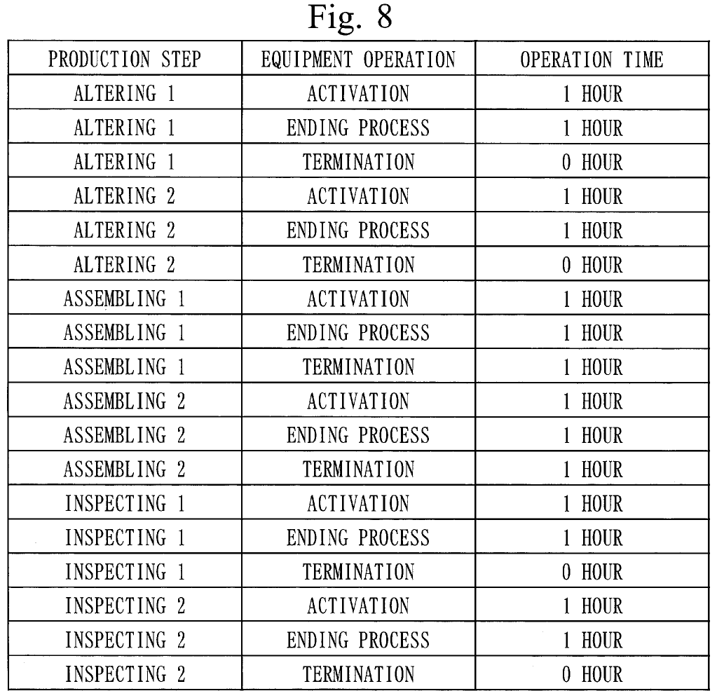

The equipment operation information indicates time required for the equipment operation of the production equipment 1 in each production step. FIG. 8 indicates an example of the equipment operation information. Details of FIG. 8 will be described later.

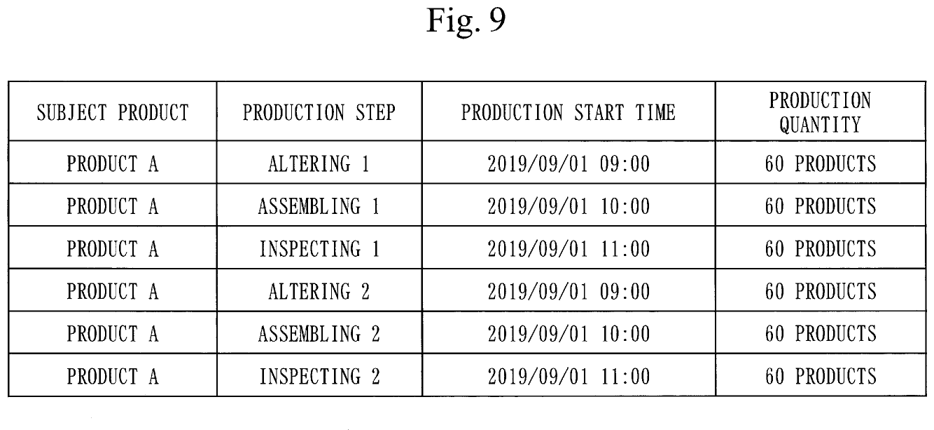

The production plan information indicates start time to start the production of the products and a production quantity for producing. FIG. 9 indicates an example of the production plan information. Details of FIG. 9 will be described later.

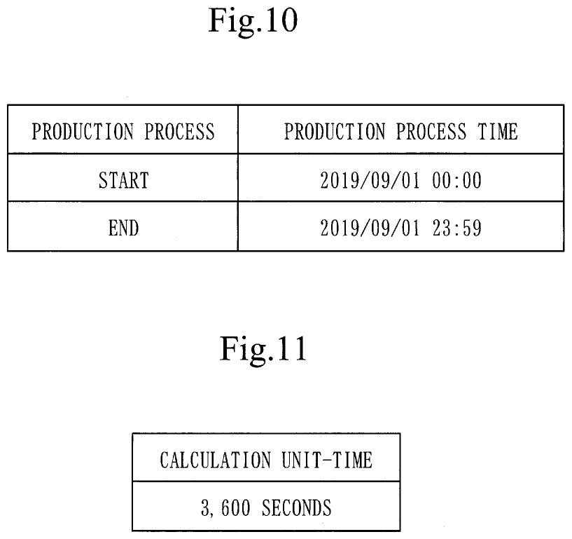

The calculation time information indicates operation-possible time of the production equipment 1 used for the calculation. FIG. 10 indicates an example of the calculation time information. Details of FIG. 10 will be described later.

The calculation unit-time information indicates unit time for calculating the production equipment operation status. FIG. 11 indicates an example of the calculation unit-time information. Details of FIG. 11 will be described later.

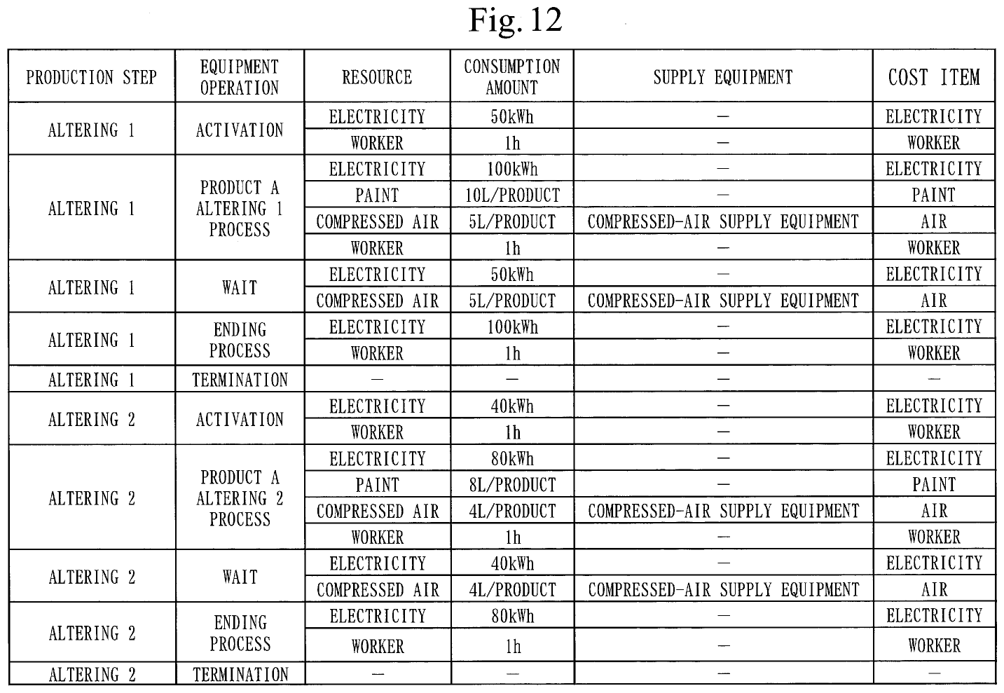

The production resource information indicates the resources (consumption resources) consumed in each production step. FIGS. 12, 13, and 14 indicate an example of the production resource information. Details of FIGS. 12, 13, and 14 will be described later.

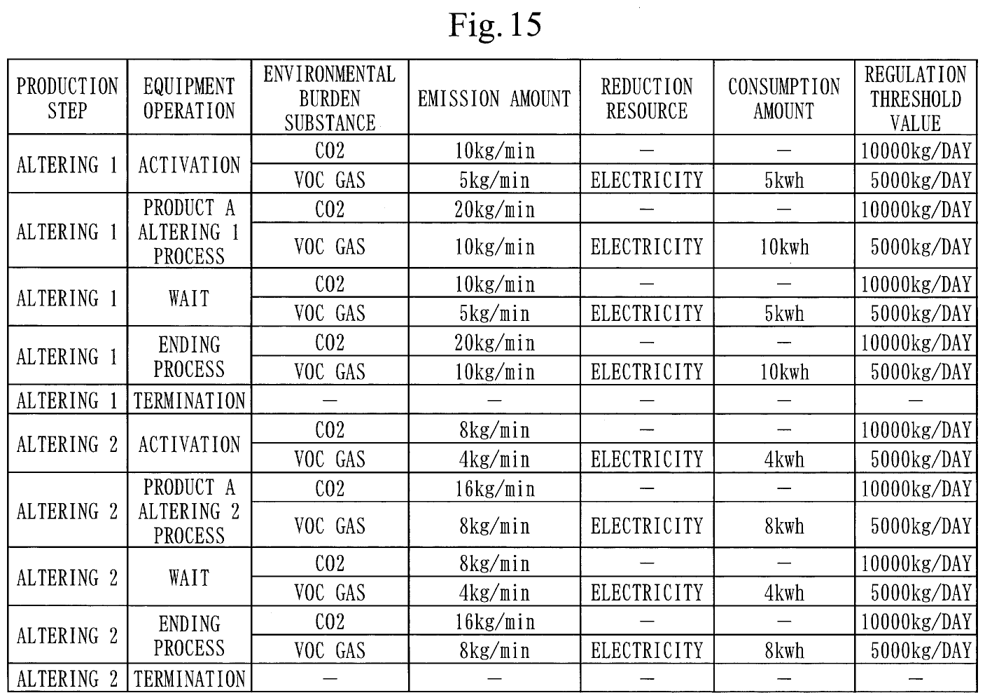

The environmental burden information indicates the environmental burden substance emitted in each production step and the resources (environmental burden reduction resources) consumed for the environmental burden reduction. FIGS. 15, 16, and 17 indicate an example of the environmental burden information. Details of FIGS. 15, 16, and 17 will be described later.

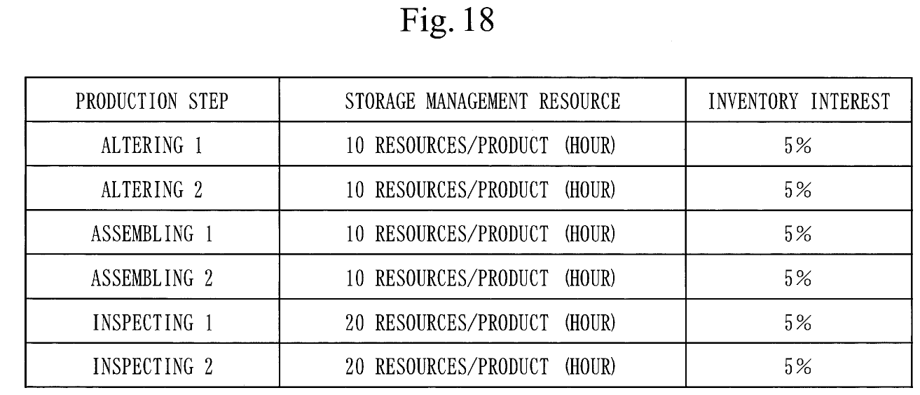

The inventory management information indicates the resources (inventory management resources) used for management of the inventory retained in the production step. Interest and the storage management resources are used as the inventory management resources. FIG. 18 indicates an example of the inventory management information. Details of FIG. 18 will be described later.

The supply equipment operation status calculation unit 413 acquires from the supply calculation database 432, the supply equipment information acquired from the supply equipment 3 by the communication control unit 412.

The supply equipment information is constituted by supply equipment operation plan information and supply resource information.

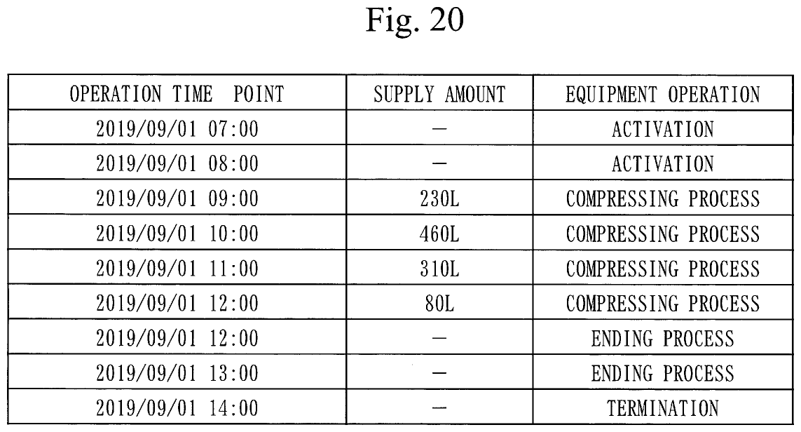

The supply equipment operation plan information indicates a plan of the equipment operation of the supply equipment 3. FIG. 20 indicates an example of the supply equipment operation plan information. Details of FIG. 20 will be described later.

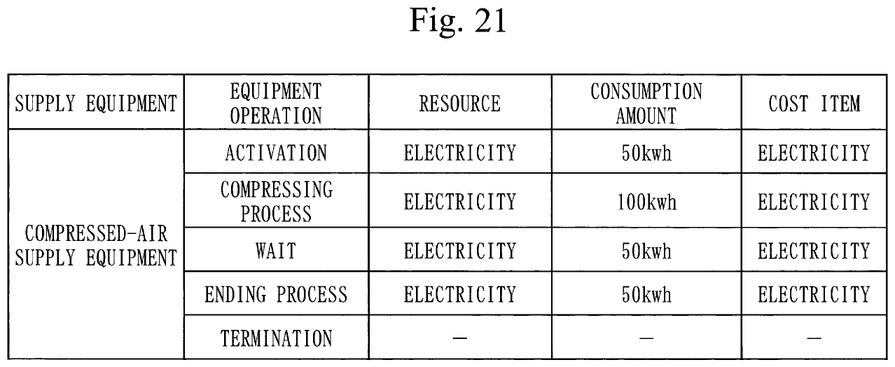

The supply resource information indicates the resource consumed in each supply equipment 3. FIG. 21 indicates an example of the supply resource information. Details of FIG. 21 will be described later.

The supply resource information does not need to be included in the supply equipment information acquired by the communication control unit 412 from the supply equipment 3. In this case, it is assumed that the supply resource information has been stored in the supply calculation database 432 of the memory 43 beforehand.

The supply equipment operation status calculation unit 413 calculates supply equipment operation status of the supply equipment 3 based on the acquired supply equipment operation plan information and the acquired supply resource information. Then, the supply equipment operation status calculation unit 413 generates supply equipment operation status information which indicates the supply equipment operation status.

The resource consumption calculation unit 414 calculates the necessary resource amount which is the amount of resources necessary in the production equipment 1 and the supply equipment 3.

The resource consumption calculation unit 414 acquires the production equipment operation status information of the production equipment 1 from the production calculation database 431 of the memory 43. Further, the resource consumption calculation unit 414 acquires the supply equipment operation status information of the supply equipment 3 from the supply calculation database 432. Then, the resource consumption calculation unit 414 totals up the resources required in each production step in the production equipment 1 and the supply equipment 3, based on the acquired production equipment operation status information and the acquired supply equipment operation status information. Then, the resource consumption calculation unit 414 calculates the necessary resource amount for each production step and each resource.

As described above, the necessary resource amount information is information exemplified in FIG. 23.

The cost calculation unit 415 calculates costs of the resources consumed in the production equipment 1 and the supply equipment 3.

The cost calculation unit 415 acquires the necessary resource amount information from the resource consumption calculation unit 414. Further, the cost calculation unit 415 acquires the cost item information from the cost item database 433 of the memory 43. Then, the cost calculation unit 415 generates the cost information based on the acquired necessary resource amount information and the acquired cost item information.

As described above, the cost information is information exemplified in FIG. 25.

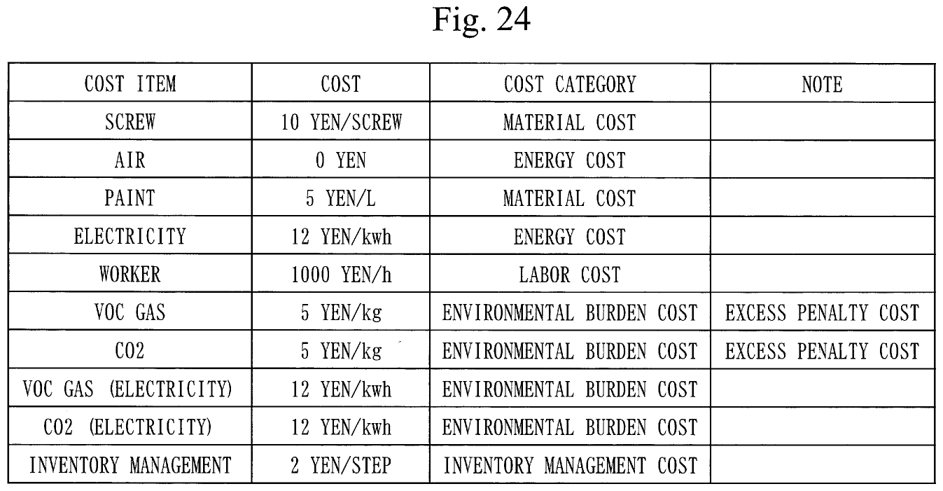

FIG. 24 illustrates an example of the cost item information. Details of FIG. 24 will be described later.

The production evaluation index calculation unit 416 acquires the cost information from the cost calculation unit 415. Then, the production evaluation index calculation unit 416 generates the production evaluation index information based on the acquired cost information. The production evaluation index information indicates the production evaluation index which is an index for optimization of the production plan. As described above, the production evaluation index information is information exemplified in FIG. 26.

The communication control unit 412 controls communication with the production control device 2, the supply equipment 3, and the display device 5 via the communication unit 44.

Next, the step information, the productivity information, the step operation information, the equipment operation information, the production plan information, the calculation time information, the calculation unit-time information, and the production resource information which are the production equipment information will be described with reference to FIGS. 4 to 14.

Note that, below, it is assumed that the pieces of supply equipment 3 are compressed-air supply equipment and a water reuse equipment. The compressed-air supply equipment is equipment that supplies compressed air to the production equipment 1.

FIG. 4 illustrates an example of the step information according to the first embodiment.

In the step information, production steps in the production equipment 1 are indicated.

The step information of FIG. 4 is master data of the production steps regarding a product A.

In FIG. 4, a column of a production line, a production line to which each production step belongs is indicated.

In a column of a step number, the order of the steps is indicated. A production step which has a smaller value of the step number is an upstream step, and a step which has a larger value of the step number is a downstream step.

Here, altering indicates an altering step for altering the materials to be parts. Assembling indicates an assembling step for assembling the parts into the products. Inspecting indicates an inspecting step for inspecting whether quality of the produced products meets a criterion.

FIG. 5 illustrates the order in the production steps according to the first embodiment.

FIG. 5 illustrates the master data of the production steps of the product A, which is illustrated in FIG. 4, by a flow.

The production steps of the product A are performed in order of the altering, the assembling, and the inspecting in a No. 1 line and a No. 2 line.

FIG. 6 illustrates an example of the productivity information according to the first embodiment.

As illustrated in FIG. 6, the productivity information is constituted by the production step, the product, and production ability.

In a column of the production step, each production step which is indicated in the column of the production step of FIG. 4 is indicated. In a column of the product, the product to be produced is indicated. In a column of the production ability, process time required for one product in each production step is indicated. An example of FIG. 6 indicates that each of altering 1, assembling 1, and the inspecting 1 has the production ability of 120 seconds/product. Further, the example of FIG. 6 indicates that each of altering 2, assembling 2, and the inspecting 2 has the production ability of 180 seconds/product.

FIG. 7 illustrates an example of the step operation information according to the first embodiment.

As illustrated in FIG. 7, the step operation information is constituted by the production step and the equipment operation.

In a column of the production step, each production step which is indicated in the column of the production step of FIG. 4 is indicated. In a column of the equipment operation, the operation of the production equipment 1 used in each production step is indicated.

In the equipment operation, activation is operation of activating the production equipment 1 used in the production step. An altering process is operation of altering the product by the production equipment 1 used in the production step. An assembling process is operation of assembling the product by the production equipment 1 used in the production step. An inspecting process is operation of inspecting the product by the production equipment 1 used in the production step. Wait is operation of putting the production equipment 1 into wait status with no process performed because of no product to be processed. An ending process is operation performed by the production equipment 1 used in the production step, of ending the processes of the production step. Termination is operation of terminating the production equipment 1 used in the production step.

FIG. 8 illustrates an example of the equipment operation information according to the first embodiment.

As illustrated in FIG. 8, the equipment operation information is constituted by the production step, the equipment operation, and operation time.

In a column of the production step, each production step which is indicated in the column of the production step in FIG. 4 is indicated. In a column of the equipment operation, the equipment operation indicated in the column of the equipment operation of FIG. 7 is indicated. In a column of the operation time, time required for each equipment operation is indicated.

FIG. 9 illustrates an example of the production plan information according to the first embodiment.

As illustrated in FIG. 9, the production plan information is constituted by a subject product, the production step, production start time, and the production quantity.

In a column of the subject product, the product to be produced is indicated. In a column of the production step, each production step which is indicated in the column of the production step of FIG. 4 is indicated. In a column of the production start time, time to start each production step at is indicated. In a column of the production quantity, the production quantity of the subject product is indicated.

FIG. 10 illustrates an example of the calculation time information according to the first embodiment.

As illustrated in FIG. 10, the calculation time information is constituted by a production process and production process time.

In a column of the production process, a start or an end of the production step is indicated. In a column of the production process time, start time or end time of the production step is indicated.

FIG. 11 illustrates an example of the calculation unit-time information according to the first embodiment.

As illustrated in FIG. 11, the calculation unit-time information is constituted by the calculation unit-time.

In a column of the calculation unit-time, unit time for the production equipment operation status calculation unit 411 to calculate process status in the product step in the production equipment 1 is indicated.

As illustrated in FIG. 11, the production equipment operation status calculation unit 411 calculates the production equipment operation status in the production step in the production equipment 1 every 3,600 seconds. Note that, the calculation unit-time may be times other than 3,600 seconds. For example, the calculation unit-time may be 7,200 seconds, 10,800 seconds, or the like.

FIGS. 12 to 14 illustrate an example of the production resource information in each production step.

FIG. 12 illustrates an example of the production resource information in the altering 1 and the altering 2.

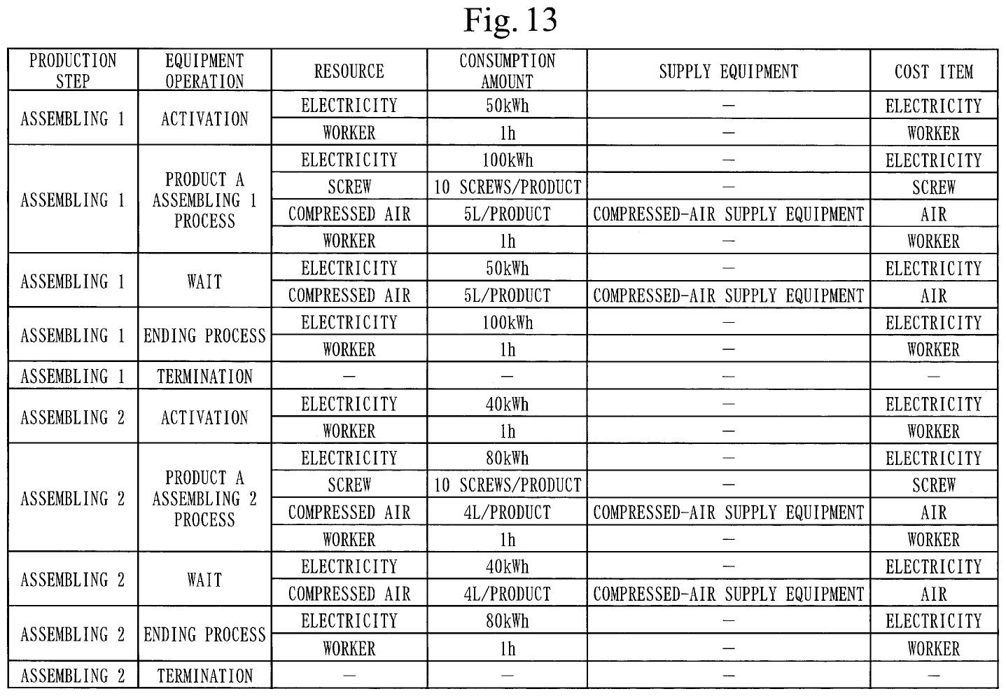

FIG. 13 illustrates an example of the production resource information in the assembling 1 and the assembling 2.

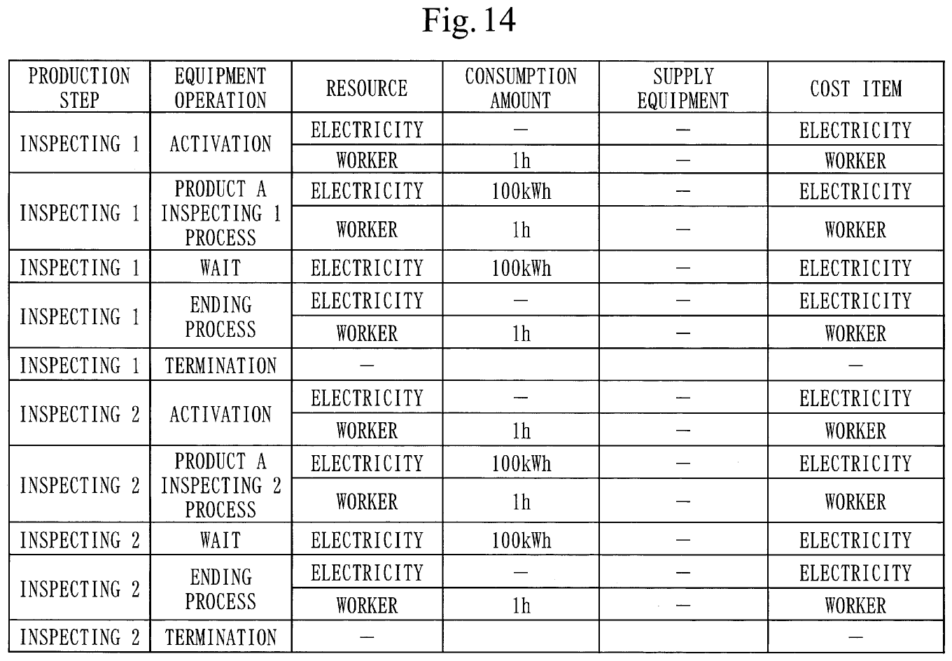

FIG. 14 illustrates an example of the production resource information in the inspecting 1 and the inspecting 2.

As illustrated in FIGS. 12 to 14, the production resource information is constituted by the production step, the equipment operation, the resource, a consumption amount, the supply equipment, and a cost item.

In a column of the production step, each production step which is indicated in the column of the production step of FIG. 4 is indicated. In a column of the equipment operation, the equipment operation which is indicated in the column of the equipment operation in FIG. 8 is indicated. In a column of the resource, resources used in the equipment operation indicated in the column of the equipment operation are indicated. In a column of the consumption amount, the consumption amount of resources is indicated. In a column of the supply equipment, the supply equipment 3 which is a supply source of the resources is indicated. In a column of the cost item, a name of the resource for cost management is indicated.

For example, in FIG. 12, in the activation of the altering 1, electricity and a worker are used as the resources. Then, the consumption amount of electricity is 50 kWh. Further, the consumption amount for the worker is 1 h. Then, the cost item of the electricity is electricity, and the cost item of the worker is a worker.

FIGS. 15 to 17 illustrate examples of the environmental burden information in each production step.

FIG. 15 illustrates an example of the environmental burden information in the altering 1 and the altering 2.

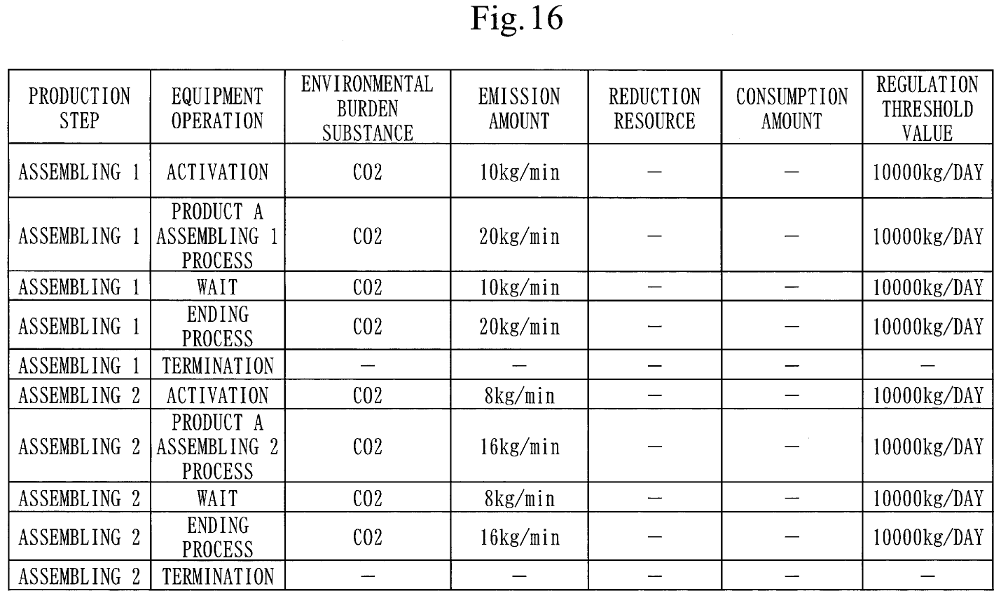

FIG. 16 illustrates an example of the environmental burden information in the assembling 1 and the assembling 2.

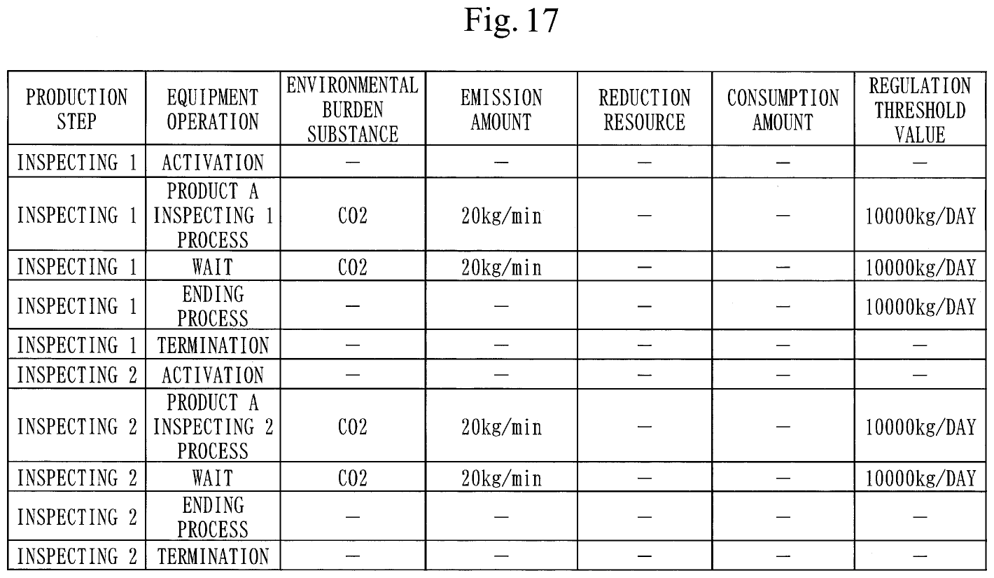

FIG. 17 illustrates an example of the environmental burden information in the inspecting 1 and the inspecting 2.

As illustrated in FIGS. 15 to 17, the environmental burden information is constituted by the production step, the equipment operation, the environmental burden substance, an emission amount, a reduction resource, the consumption amount, and a regulation threshold value.

In a column of the production step, each production step which is indicated in the column of the production step of FIG. 4 is indicated. In a column of the equipment operation, the equipment operation which is indicated in the column of the equipment operation of FIG. 8 is indicated. In a column of the environmental burden substance, a substance which causes the environmental burden is indicated. In a column of the emission amount, the emission amount of environmental burden substances is indicated. In a column of the reduction resource, a reduction resource used for reducing emission of the environmental burden substance is indicated. In a column of the consumption amount, the consumption amount of the reduction resource is indicated. In a column of the regulation threshold value, a regulation upper limit value of the emission amount of the environmental burden substance is indicated.

For example, in the activation of the altering 1, the VOC gas is emitted at a rate of 5 kg/min, and in order for the emission of the VOC gas in the activation of the altering 1 to be smaller than 5000 kg/day, the electricity needs to be consumed at a rate of 5 kwh.

FIG. 18 illustrates an example of the inventory management information according to the first embodiment.

As illustrated in FIG. 18, the inventory management information is constituted by the production step, the storage management resource, and inventory interest.

In a column of the production step, each production step which is indicated in the column of the production step of FIG. 4 is indicated. In a column of the storage management resource, a storage management resource per one inventory and per one hour is indicated. The storage management resource indicates, a work amount by a human or a machine, and a light and heat usage amount. In a column of the inventory interest, interest imposed on the inventory is indicated.

FIG. 19 illustrates an example of the production equipment operation status information according to the first embodiment.

Below, with reference to FIG. 19, a method will be described according to which the production equipment operation status calculation unit 411 calculates operation status of the production equipment 1, that is process status of the production step that the production equipment 1 implements.

Note that, below, it is assumed that time required for transportation of the product between the production steps is included in time of the production process in each production step. Further, the transportation of the product between the production steps is performed every one hour. Further, it is assumed that the product produced in each production step is transported to the next production step.

The production equipment operation status calculation unit 411 calculates the production equipment operation status for each production step based on the production equipment information. As described above, the production equipment information includes the step information, the productivity information, the step operation information, the equipment operation information, the production plan information, the calculation time information, the calculation unit-time information, the production resource information, the environmental burden information, and the inventory management information which are indicated in FIG. 4, and FIGS. 6 to 18.

Specifically, the production equipment operation status calculation unit 411 generates for each production step indicated in the step information of FIG. 4, a value of the production step, a value of the operation time point, a value of a product name, a value of the production quantity, and a value of the equipment operation, which are in FIG. 19, based on the equipment operation information of FIG. 8, the productivity information of FIG. 6, the step operation information of FIG. 7, and the production plan information of FIG. 9.

Here, an example will be described in which the production equipment operation status calculation unit 411 generates the production equipment operation status information of FIG. 19 for the “altering 1” in FIG. 4.

The production equipment operation status calculation unit 411 acquires from the step operation information of FIG. 7, the “activation”, “product A altering 1 process”, the “wait”, the “ending process”, and the “termination” as the equipment operation of the “altering 1”.

The production equipment operation status calculation unit 411 acquires from the equipment operation information of FIG. 8 for the “altering 1”, “1 hour” as operation time of the activation, “1 hour” as operation time of the ending process, and “0 hour” as operation time of the termination.

Further, the production equipment operation status calculation unit 411 acquires from the productivity information of FIG. 6 for the “altering 1”, “product A” as the product, and “120 seconds/product” as the production ability.

Further, the production equipment operation status calculation unit 411 acquires from the production plan information of FIG. 9 for the “altering 1”, “2019/09/01 09:00” as the production start time and “60 products” as the production quantity.

Then, for the “altering 1”, since “1 hour” is required as the operation time of the activation and the production start time is “2019/09/01 09:00”, the production equipment operation status calculation unit 411 decides that the activation of the “altering 1” starts at “2019/09/01 08:00”. Further, since the production quantity of “product A” is “60 products” and the production ability of the “product A” is “120 seconds/product”, the production equipment operation status calculation unit 411 determines that the “product A altering 1 process” in the “altering 1” requires 2 hours (60 products*120 seconds/3600 seconds=2 hours). Therefore, the production equipment operation status calculation unit 411 determines that the altering process for 30 products is performed during 1 hour from “2019/09/01 09:00” and the altering process for 30 products is performed during 1 hour from “2019/09/01 10:00”. Further, the production equipment operation status calculation unit 411 determines that the “ending process” of the “altering 1” starts at “2019/09/01 11:00”.

Further, for the “altering 1”, since “1 hour” is required for the operation time of “ending process”, the production equipment operation status calculation unit 411 determines that the “termination” of the “altering 1” is performed at “2019/09/01 12:00”.

From the above analysis, the production equipment operation status calculation unit 411 generates a value of the production step, a value of the operation time point, a value of the product name, a value of the production quantity, and a value of the equipment operation which are in FIG. 19.

Further, the production equipment operation status calculation unit 411 generates a value of the consumption resource, a value of the environmental burden substance, and a value of the environmental burden reduction resource, which are in FIG. 19, based on the production resource information of FIGS. 12 to 14 and the environmental burden information of FIGS. 15 to 17.

Also here, an example will be described in which the production equipment operation status calculation unit 411 generates the production equipment operation status information of FIG. 19 for the “altering 1” of FIG. 4.

For the “altering 1”, the production equipment operation status calculation unit 411 acquires from the production resource information of FIG. 12 for each equipment operation, a value indicated in the column of the resource, a value indicated in the column of the consumption amount, and a value indicated in the column of the cost item.

Further, for the “altering 1”, the production equipment operation status calculation unit 411 acquires from the environmental burden information of FIG. 15 for each equipment operation, a value of the column of the environmental burden substance, a value of the column of the emission amount, a value of the column of the reduction resource, and a value of the column of the consumption amount.

Then, the production equipment operation status calculation unit 411 generates the values of the consumption resource in FIG. 19, using the values acquired from the production resource information of FIG. 12.

Further, the production equipment operation status calculation unit 411 generates the values of the environmental burden substance and the values of the environmental burden reduction resource which are in FIG. 19, using the values acquired from the environmental burden information of FIG. 15.

Next, the production equipment operation status calculation unit 411 stores in the production calculation database 431 of the memory 43, the generated production equipment operation status information (FIG. 19).

Next, the communication control unit 412 acquires the production equipment operation status information (FIG. 19) from the production calculation database 431 of the memory 43. Then, from the acquired production equipment operation status information, the communication control unit 412 extracts the consumption amount of the consumption resource with which the supply equipment is associated, and the operation time point of the equipment operation which consumes the consumption resource. Then, the communication control unit 412 specifies the supply equipment 3 that supplies the extracted consumption resource. Specifically, the communication control unit 412 refers to the production resource information indicated in FIGS. 12 to 14, and specifies the supply equipment 3. Then, the communication control unit 412 outputs to a corresponding supply equipment 3, an instruction to request for outputting the supply equipment information which is for a case where the consumption resource of the consumption quantity is supplied at the operation time point.

After that, the communication control unit 412 acquires the supply equipment information from the supply equipment 3, and stores in the memory 43, the acquired supply equipment information as the supply calculation database 432.

Here, the supply equipment information is constituted by the supply equipment operation plan information and the supply resource information. The supply equipment operation plan information is information that indicates a plan of the equipment operation of the supply equipment 3. The supply resource information is information that indicates the resource consumed in each supply equipment 3. Note that, the supply resource information may be stored in the supply calculation database 432 of the memory 43 beforehand, instead of being included in the supply equipment information acquired by the communication control unit 412 from the supply equipment 3.

FIG. 20 illustrates an example of the supply equipment operation plan information of the supply equipment 3.

FIG. 20 illustrates an example of the supply equipment operation plan information of the compressed-air supply equipment which is an example of the supply equipment 3.

FIG. 21 illustrates an example of the supply resource information of the compressed-air supply equipment.

The supply equipment operation plan information of FIG. 20 and the supply resource information of FIG. 21 are collectively referred to as the supply equipment information.

As illustrated in FIG. 20, the supply equipment operation plan information for the compressed-air supply equipment is constituted by the operation time point, a supply amount, and the equipment operation.

In a column of the operation time point, the operation time point at which the compressed-air supply equipment operates is indicated at intervals of a calculation unit-time. In a column of the supply amount, the supply amount of compressed air is indicated. In a column of the equipment operation, the operation of the compressed-air supply equipment is indicated. Here, a “compressing process” in the equipment operation is operation for compressing air and supplying the compressed air to the production equipment 1.

Next, as illustrated in FIG. 21, the supply resource information is constituted by the supply equipment, the equipment operation, the resource, the consumption amount, and the cost item.

In a column of the supply equipment, the supply equipment 3 that supplies the resource is indicated. In a column of the equipment operation, the operation of the supply equipment 3 is indicated. In a column of the resource, the resource consumed in the equipment operation is indicated. In a column of the consumption amount, the consumption amount of resources is indicated. In a column of the cost item, a name of the resource for cost management is indicated.

Here, the reason why the compressed-air is not indicated as the resource is because the compressed air does not require a cost, in other words, the compressed air is the resource that does not have the cost item, therefore, the consumption amount does not need to be considered.

The supply equipment operation status calculation unit 413 acquires the supply equipment information (FIGS. 20 and 21) from the supply calculation database 432 of the memory 43, and calculates the supply equipment operation status of the supply equipment 3 based on the acquired supply equipment information.

Below, an example will be described in which the supply equipment operation status calculation unit 413 calculates the supply equipment operation status for the compressed-air supply equipment which is the supply equipment 3.

First, the supply equipment operation status calculation unit 413 acquires from the supply calculation database 432 of the memory 43, the supply equipment operation plan information (FIG. 20) and the supply resource information (FIG. 21) which are the supply equipment information of the compressed air supply equipment which is the supply equipment 3.

Next, the supply equipment operation status calculation unit 413 calculates the supply equipment operation status of the compressed-air supply equipment based on the acquired supply equipment operation plan information and the acquired supply resource information, and generates the supply equipment operation status information.

FIG. 22 illustrates an example of the supply equipment operation status information of the compressed-air supply equipment according the first embodiment.

As illustrated in FIG. 22, the supply equipment operation status information of the compressed-air supply equipment is constituted by the supply equipment, the operation time point, the supply amount, the equipment operation, and the supply equipment resource.

A value of a column of the supply equipment in FIG. 22 is acquired from the value of the column of the supply equipment in FIG. 21. A value of a column of an operation date and time in FIG. 22 is acquired from the value of the column of the operation date and time in FIG. 20. A value of a column of the supply amount in FIG. 22 is acquired from the value of the column of the supply amount in FIG. 20. A value of a column of the equipment operation in FIG. 22 is acquired from the value of the column of the equipment operation in FIG. 20. A value of a column of the supply equipment resource in FIG. 22 is acquired from the value of the column of the resource and the value of the column of the consumption amount which are in FIG. 21.

The resource consumption calculation unit 414 acquires the production equipment operation status information (FIG. 19) of the production equipment 1 from the production calculation database 431 of the memory 43, and acquires the supply equipment operation status information (FIG. 22) of the supply equipment 3 from the supply calculation database 432.

Then, the resource consumption calculation unit 414 totals up the necessary amounts of resource consumed in each production step in the production equipment 1 and the supply equipment 3 based on the acquired production equipment operation status information and the acquired supply equipment operation status information. Then, the resource consumption calculation unit 414 generates the necessary resource amount information that indicates the necessary amount (necessary resource amount) of resource acquired by the totaling up.

FIG. 23 illustrates an example of the necessary resource amount information according to the first embodiment.

As illustrated in FIG. 23, in the necessary resource amount information, the necessary resource amount of consumption resource, the necessary resource amount of environmental burden reduction resource, and the necessary resource amount of inventory management resource are indicated for each production step.

The resource consumption calculation unit 414 calculates a value of the necessary resource amount of consumption resource, a value of the necessary resource amount of environmental burden reduction resource, and a value of the necessary resource amount of inventory management resource based on the production equipment operation status information of FIG. 19.

Further, the resource consumption calculation unit 414 calculates the necessary resource amount of supply equipment resource based on the supply equipment operation status information of FIG. 22.

The cost calculation unit 415 acquires the necessary resource amount information (FIG. 23) from the resource consumption calculation unit 414, and acquires cost item information from the cost item database 433 of the memory 43. Then, the cost calculation unit 415 calculates for each production step, the costs of the resource which is required in the production equipment 1 and the supply equipment 3, based on the acquired necessary resource amount information and the acquired cost item information. Then, the cost calculation unit 415 generates the cost information.

FIG. 24 illustrates an example of the cost item information according to the first embodiment.

As illustrated in FIG. 24, the cost item information is constituted by the cost item, a cost, and a cost classification.

Except for the “inventory management”, the cost item corresponds to the cost item included in the production resource information indicated in FIGS. 12 to 14 and the cost item included in the supply resource information indicated in FIG. 21.

In a column of the cost, a cost unit-price is indicated for each cost item. In a column of the cost classification, a classification of the cost in the purpose category is indicated.

Note that, a note illustrated in FIG. 24 is provided for a reason of reference, and not included in the cost item information.

FIG. 25 illustrates an example of the cost information according to the first embodiment.

As illustrated in FIG. 25, configuration of the cost information is the same as the configuration of the necessary resource amount information of FIG. 23. Note that the necessary resource amount is indicated for each production step and each type of the resources in the necessary resource amount information of FIG. 23, however, in the cost information of FIG. 25, the cost is indicated for each production step and each type of the resources.

For the resources other than the inventory management resource, the cost calculation unit 415 calculates the cost of each resource by multiplying the necessary resource amount indicated in the necessary resource amount information of FIG. 23 by the value of the cost indicated in the cost item information of FIG. 24.

For the inventory management resource, the cost calculation unit 415 calculates the cost according to a below equation 1.

inventory management cost=Σ[(inventory quantity)*(material cost)*(inventory interest)/100+(inventory quantity)*(retention time)*(inventory management cost)*(inventory management resource)] equation 1

The production evaluation index calculation unit 416 acquires the cost information (FIG. 25) from the cost calculation unit 415, and calculates the production index which is an index for the optimization of the production plan based on the acquired cost information.

More specifically, the production evaluation index calculation unit 416 assigns each resource to one of the purpose categories according to the purpose of the resource for each production step. Then, the production evaluation index calculation unit 416 aggregates the costs of the resource for each production step and each purpose category. Further, the production evaluation index calculation unit 416 indexes the aggregation result of the costs in the plurality of purpose categories in the plurality of production steps. The aggregation result of the costs which is indexed by the production evaluation index calculation unit 416 is referred to as the production evaluation index.

FIG. 26 illustrates an example of the production evaluation index information according to the first embodiment.

The production evaluation index information indicates for each production step, the production evaluation index for each purpose category which is calculated by the production evaluation index calculation unit 416.

In an example of FIG. 26, there are the material category, the energy category, the environmental burden category, and the inventory management category as the purpose categories.

The production evaluation index of the material category is a total of the values acquired by multiplying the material cost and a labor cost by load time, and by dividing the multiplied value by the production quantity (equation 2). In an example of FIG. 25, the material cost is values of a screw and paint. In the example of FIG. 25, the labor cost is a value of the worker. Here, the load time is, as indicated in equation 6, time acquired by subtracting plan stop time from operation time which is based on a current production plan.

The production evaluation index of the energy category is a total of the values acquired by multiplying an energy cost by the load time, and by dividing the multiplied value by the production quantity (equation 3). In an example of FIG. 25, the energy cost is values of the air and the electricity.

The production evaluation index of the environmental burden category is a total of the values acquired by multiplying an environmental burden reduction cost by the load time, and by dividing the multiplied value by the production quantity (equation 4). In an example of FIG. 25, the environmental burden reduction cost is a value of VOC (electricity).

The production evaluation index of the inventory management category is a total of the values acquired by multiplying the inventory management cost by the load time, and by dividing the multiplied value by the production quantity (equation 5). In an example of FIG. 25, the inventory management cost is a value of the storage management resource.

(material)=Σ{(material cost)+(labor cost)}*(load time)/(production quantity) equation 2

(energy)=Σ(energy cost)*(load time)/(production quantity) equation 3

(environmental burden)=Σ(environmental burden cost)*(load time)/(production quantity) equation 4

(inventory management)=Σ(inventory management cost)*(load time)/(production quantity) equation 5

(load time)=(operation time)−(plan stop time) equation 6

After the production evaluation index for each purpose category is obtained as described above, the production evaluation index calculation unit 416 calculates the evaluation value of the production plan, using the production evaluation index for each purpose category and a weight coefficient for each purpose category. The evaluation value is an integrated index value of the production evaluation indexes for each purpose category.

Specifically, the production evaluation index calculation unit 416 calculates the evaluation value of the production plan according to equation 7.

Note that, the more proper the production plan is, the smaller the evaluation value acquired from the equation 7 is.

(Evaluation Value)=w1*(Material)+w2*(Energy)+w3*(Environmental Burden reduction)+W4*(inventory management) equation 7

w1, w2, w3, and w4: weight coefficient (set by a user)

w1, w2, w3, and w4 which are the weight coefficients can be set by the user as necessary according to situations such as environment of a production site, priority of evaluation, and decimal alignment of each member of the equation.

The production evaluation index calculation unit 416 outputs the generated evaluation value to the display device 5. As a result, the evaluation value is presented to the user by the display device 5.

The production evaluation index calculation unit 416 may output to the display device 5, the production evaluation index information illustrated in FIG. 26 in addition to the evaluation value. In this case, the production evaluation index for each purpose category is presented to the user by the display device 5.

Further, the production evaluation index calculation unit 416 may output only the production evaluation index information to the display device 5.

As described above, in the present embodiment, it is possible to present to the user, at least one of the evaluation value and the production evaluation index which is for each purpose category.

For this reason, according to the present embodiment, the user can generate the proper production plan by considering the productivity, the energy efficiency, the environmental burden reduction, and the inventory management from an aspect of the cost.

*** Description of Operation ***

Next, a flow of a production plan generation process according to the present embodiment will be described.

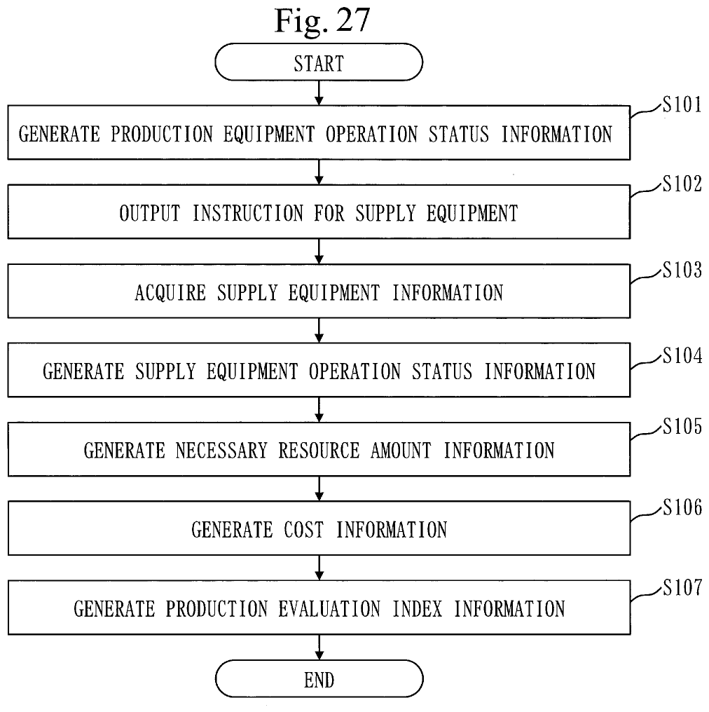

FIG. 27 is a flowchart indicating an example of the flow of the production plan generation process according to the present embodiment.

First, the production equipment operation status calculation unit 411 receives a request for the production plan generation process from the user, and starts the production plan generation process.

Further, the production equipment operation status calculation unit 411 may start the production plan generation process autonomously.

As a method for the user to request to start the production plan generation process, it is considered to display a start button for the production plan generation process on the display device 5, and to press the start button by the user. The user may request to start the production plan generation process by a different method.

As a method for the production equipment operation status calculation unit 411 to start the production plan generation process autonomously, for example, it is considered to start the production plan generation process, triggered by storing the production plan information illustrated in FIG. 9 in the storage 42. The production equipment operation status calculation unit 411 may start the production plan generation process autonomously by a different method.

In step S101, the production equipment operation status calculation unit 411 generates the production equipment operation status information (FIG. 19) based on the production equipment information. Then, the production equipment operation status calculation unit 411 stores the production equipment operation status information in the production calculation database 431.

Here, the production equipment information is information stored in the production calculation database 431 of the memory 43. The production equipment information is, as described above, constituted by the step information (FIG. 5), the productivity information (FIG. 6), the step operation information (FIG. 7), the equipment operation information (FIG. 8), the production plan information (FIG. 9), the calculation time information (FIG. 10), the calculation unit-time information (FIG. 11), the production resource information (FIGS. 12 to 14), the environmental burden information (FIGS. 15 to 17), and the inventory management information (FIG. 18).

Next, in step S102, the communication control unit 412 generates an instruction for the supply equipment 3, based on the production equipment operation status information generated in step S101, and outputs the instruction to the supply equipment 3.

Here, the instruction generated by the communication control unit 412 is an instruction to request the supply equipment 3 to output the supply equipment information.

Next, in step S103, the communication control unit 412 acquires the supply equipment information from the supply equipment 3 via the communication unit 44, and stores the supply equipment information in the supply calculation database 432.

The supply equipment information is, as described above, constituted by the supply equipment operation plan information (FIG. 20) and the supply resource information (FIG. 21).

Next, in step S104, the supply equipment operation status calculation unit 413 generates the supply equipment operation status information (FIG. 22) based on the supply equipment information, and stores the supply equipment operation status information in the supply calculation database 432.

Next, in step S105, the resource consumption calculation unit 414 generates the necessary resource amount information (FIG. 23) based on the production equipment operation status information (FIG. 19) and the supply equipment operation status information (FIG. 22).

Next, in step S106, the cost calculation unit 415 generates the cost information (FIG. 25) based on the necessary resource amount information (FIG. 23) and the cost item information (FIG. 24).

Here, the cost item information is information stored in the cost item database 433 of the memory 43.

Next, in step S107, the production evaluation index calculation unit 416 generates the production evaluation index information (FIG. 26) which is an index for the optimization of the production plan, based on the cost information (FIG. 25).

Note that, as described above, the production evaluation index calculation unit 416 may calculate the evaluation value based on the production evaluation index information.

Further, the production evaluation index calculation unit 416 may output to the display device 5, at least one of the evaluation value and the production evaluation index information.

*** Description of Effect of Embodiment ***

As described above, according to the present embodiment, it is possible to generate the production evaluation index involving consideration on the productivity, the energy efficiency, the environmental burden, and the inventory management at the same time, by converting into the cost, the productivity, the energy efficiency, the environmental burden, and the inventory management which are directly related to the manufacture first cost.

Further, it is also acceptable to provide a logistic category for the production evaluation index information (FIG. 26) as a purpose category of a logistic purpose and to generate the production evaluation index for the cost required for logistic.

A logistic cost occurs, when the product (semi-finished product) from the production equipment 1 of an upstream step is transported to the production equipment 1 of a downstream step in the distance and the product is completed in the production equipment 1 in the downstream step.

In this case, the production equipment operation status calculation unit 411 extracts as a logistic resource, a resource used for the logistic. The logistic resource includes a transportation means (a vehicle, a ship, an aircraft, and the like), a packaging material, and a worker (labor) engaged in packaging and transportation. Further, as a cost of the logistic resource, for example, an arrangement cost of the transportation means, a cost of the packaging material, and a labor cost of the worker occur.

The production equipment operation status calculation unit 411 calculates the necessary resource amount of logistic resource, and adds the necessary resource amount of logistic resource to the necessary resource amount information (FIG. 23). Further, the production evaluation index calculation unit 416 creates the logistic category in the production evaluation index information (FIG. 26), and generates the production evaluation index for the logistic cost based on the necessary resource amount of logistic resource.

Further, the production plan optimization apparatus 4 may generate the production evaluation index for costs other than the logistic cost.

Further, the production evaluation index calculation unit 416 can substitute equations 2a to 5a below for the equations 2 to 5 above. The equations 2a to 5a include a squared value of the (production quantity) instead of the (production quantity). That is, the production evaluation index calculation unit 416 divides a multiplication value of the cost and the load time by the squared value of the value of the production quantity, for each purpose category, and acquires the production evaluation index for each purpose category.

(material)=Σ{(material cost)+(labor cost)}*(load time)/(production quantity) equation 2a

(energy)=Σ(energy cost)*(load time)/(production quantity) equation 3a

(environmental burden)=Σ(environmental burden cost)*(load time)/(production quantity) equation 4a

(inventory management)=Σ(inventory management cost)*(load time)/(production quantity) equation 5a

The production sometimes requires not only inexpensiveness of the cost but also speed of the production. In the equations 2 to 5, the inexpensiveness of the production is emphasized, and as indicated in a case study below, a calculation result is acquired which indicates that a “production method 1” is superior to a “production method 2”. On the other hand, in the equations 2a to 5a, the speed of the production is emphasized more compared with the equations 2 to 5. The production evaluation index calculation unit 416 can use the equations 2a to 5a above which can acquire a calculation result that the “production method 2” is superior, considering a factor of the inexpensiveness: Σ(each type of cost)/(production quantity) and a factor of the speed: (load time)/(production quantity). Consequently, the calculation result which indicates that the “production method 2” is superior to the “production method 1” is acquired, and it is possible to consider both the inexpensiveness of the production and the speed of the production, by using the equations 2a to 5a.

[production method 1] (for a reason of simple exemplification, only a cost of a (material) is calculated)

(material cost+labor cost)=200 yen

load time=20 hours

production quantity=11 products

[production method 2] (for a reason of simple exemplification, only a cost of a (material) is calculated)

(material cost+labor cost)=400 yen

load time=30 hours production quantity=20 products

In a case where the equation 2 is used (rounded to the first decimal place)

(material)=200*20/11=363 [production method 1]

(material)=400*30/20=600 [production method 2]

In a case where the equation 2a is used

(material)=200*20/102=33 [production method 1]

(material)=400*30/202=30 [production method 2]

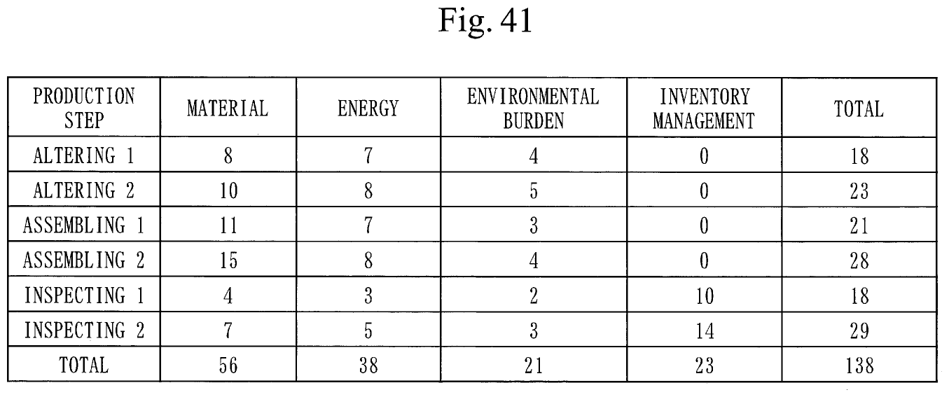

FIG. 41 is an example of the production evaluation index information which the production evaluation index calculation unit 416 has calculated using evaluation index calculation equations defined in the equations 2a to 5a above. In the production evaluation index information, an index value which is the indexed aggregation result of the costs is indicated for each production step and each purpose category. FIG. 9 (initial) is used as the production plan.

Note that, FIG. 26 is an example of the production evaluation index information the production evaluation index calculation unit 416 has calculated using evaluation index calculation equations defined in the equations 2 to 6.

### Second Embodiment

In a second embodiment, an example will be described in which whether or not the production plan needs to be changed is determined, and when the production plan needs to be changed, the production plan is changed.

In the present embodiment, mainly matters different from the first embodiment will be described.

Note that, matters not described below are the same as those in the first embodiment.

*** Description of Configuration ***

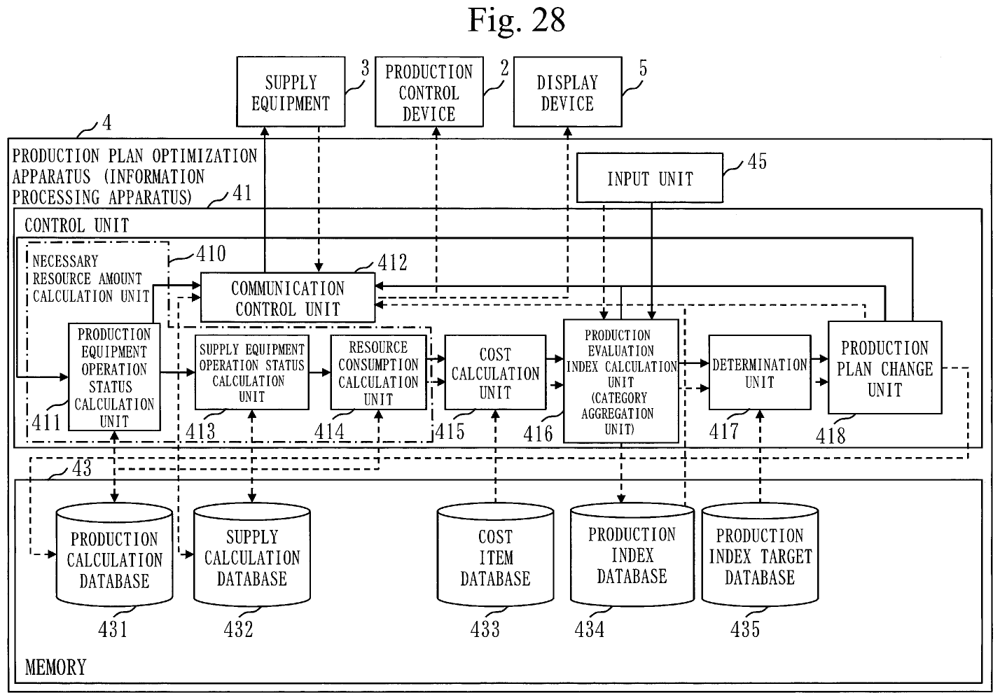

FIG. 28 illustrates a functional configuration example of the production plan optimization apparatus 4 according to the present embodiment.

Compared with FIG. 3, in FIG. 28, a determination unit 417, a production plan change unit 418, a production index target database 435, and a production index target database 435 are added.

Elements other than the determination unit 417, the production plan change unit 418, and the production index target database 435 are the same as those illustrated in FIG. 3.

The determination unit 417 and the production plan change unit 418 are included in the production plan generation program 421 as with the production equipment operation status calculation unit 411.

The determination unit 417 acquires the evaluation value of the production plan or/and the production evaluation index information (FIG. 26) from the production index database 434. The evaluation value of the production plan is the value calculated according to the above-described equation 7.

Further, the determination unit 417 acquires the production evaluation index target information from the production index target database 435.

The production evaluation index target information indicates a target value for the evaluation value or/and a target value for one of the production evaluation indexes in the production evaluation index information. The target value is a value set by the user arbitrarily. For example, the production evaluation index target information indicates as the target value, the evaluation value assumed when the production evaluation index in the purpose category designated by the user meets a requirement value from the user. Further, the production evaluation index target information may indicate as the target value, the requirement value from the user for the production evaluation index in the purpose category designated by the user.

Then, the determination unit 417 determines whether or not the production plan needs to be changed, based on the evaluation value or/and the acquired production evaluation index information (FIG. 26) and the acquired production evaluation index target information. Here, if the evaluation value or/and the production evaluation index information (FIG. 26) meet(s) the target value, the determination unit 417 determines that the production plan does not need to be changed. On the other hand, if the evaluation value or/and the production evaluation index information (FIG. 26) does/do not meet the target value, the determination unit 417 determines that the production plan needs to be changed.

When the determination unit 417 determines that the production plan does not need to be changed, the production plan change unit 418 outputs the production plan information to the production control device 2 and the display device 5 via the communication control unit 412.

On the other hand, when the determination unit 417 determines that the production plan needs to be changed, the production plan change unit 418 changes the production plan. Specifically, the production plan change unit 418 changes the production plan information so that the evaluation value of the changed production plan meets the target value of the production evaluation index target information. The production plan change unit 418 stores the changed production plan information in the production calculation database 431 of the memory 43.

When the evaluation value of the changed production plan meets the target value of the production evaluation index target information, and the determination unit 417 determines that the production plan does not need to be changed any more, the production plan change unit 418 outputs to the production control device 2 and the display device 5 via the communication control unit 412, the production plan information that indicates the changed production plan.

When the changed production plan information is stored in the production calculation database 431 by the production plan change unit 418, the production equipment operation status calculation unit 411, the communication control unit 412, the supply equipment operation status calculation unit 413, the resource consumption calculation unit 414, the cost calculation unit 415, and the production evaluation index calculation unit 416 perform on the changed production plan information, the same processes as those in the first embodiment.

That is, the production equipment operation status calculation unit 411 specifies based on the changed production plan information, the resources required in the production equipment 1 for realizing the changed production plan (generates the production equipment operation status information (FIG. 19)).

Further, the supply equipment operation status calculation unit 413 specifies based on the changed production plan information, the resources required in the supply equipment 3 for realizing the changed production plan (generates the supply equipment operation status information (FIG. 22))

Further, the resource consumption calculation unit 414 calculates as the necessary resource amount, the amount of each resource necessary for realizing the changed production plan (generates the necessary resource amount information (FIG. 23)).

Further, the cost calculation unit 415 calculates the cost which is for acquiring the necessary resource amount calculated based on the changed production plan (generates the cost information (FIG. 25)).

Further, the production evaluation index calculation unit 416 generates the production evaluation index information (FIG. 26), using the cost calculated based on the changed production plan.

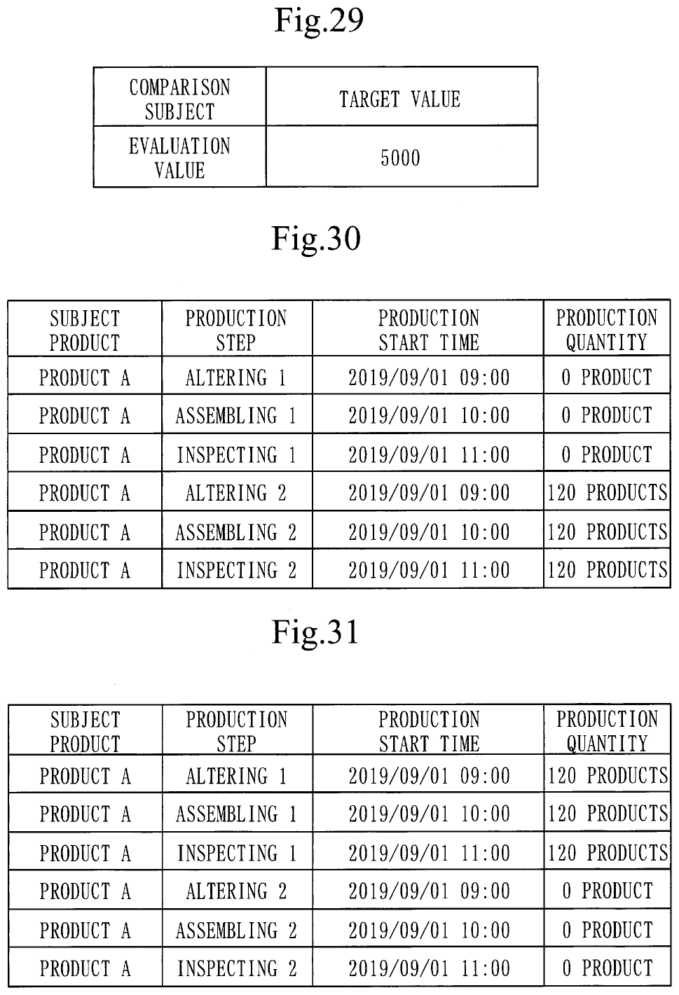

FIG. 29 illustrates an example of the production evaluation index target information according to the second embodiment. The production evaluation index target information is stored in the production index target database 435.

As illustrated in FIG. 29, the production evaluation index target information is constituted by a comparison subject and the target value.

In a column of the comparison subject, a value compared to the target value is indicated.

The target value indicates a target value for the value indicated in the column of the comparison subject.

In the example of FIG. 29, the target value for the evaluation value is indicated, however, the target value for one of the production evaluation indexes in the production evaluation index information (FIG. 26) may be set in the production evaluation index target information.

Further, both the target value for the evaluation value and the target value for one of the production evaluation indexes in the production evaluation index information (FIG. 26) may be set in the production evaluation index target information. Further, the target values for a plurality of production evaluation indexes in the production evaluation index information (FIG. 26) may be set in the production evaluation index target information. Further, the target value for the evaluation value and the target values for the plurality of the production evaluation indexes may be set in the production evaluation index target information.

When the plurality of target values are set, order of priority in the plurality of target values is also set in the production evaluation index target information. The production plan change unit 418 performs the production plan change processes according to the order of the priority, and stores in the production calculation database 431 of the memory 43, the production plan information that indicates the changed production plan.

In the present embodiment, it is assumed that the weight coefficients w1, w2, w3, and w4 indicated in the equation 7 are all 1 (w1=w2=w3=w4=1).

In this case, the evaluation value of the production plan which is acquired from the production evaluation index information of FIG. 26 is “7978” which is a total value.

The determination unit 417 compares the evaluation value “7978” with a target value “5000” in FIG. 29. In this case, since the evaluation value “7978” exceeds the target value “5000”, the determination unit 417 determines that the production plan needs to be changed.

The production plan change unit 418 changes the production plan information of FIG. 9, which is a base of the production evaluation index information (FIG. 26), to, for example, the production plan information of FIG. 30 or the production plan information of FIG. 31.

The production plan information of FIG. 9 indicates the production plan for producing 60 products in each of the No. 1 line and the No. 2 line. On the other hand, the production plan information of FIG. 30 indicates the production plan for producing 120 products in the No. 2 line only. Further, the production plan information of FIG. 31 indicates the production plan for producing 120 products in the No. 1 line only.

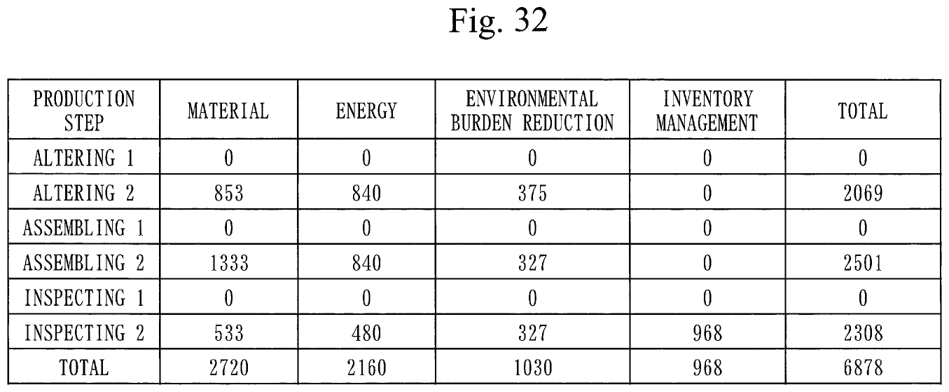

FIG. 32 illustrates the production evaluation index information acquired based on the changed production plan information illustrated in FIG. 30. The production evaluation index information of FIG. 32 has the same configuration as the production evaluation index information of FIG. 26, however, the production evaluation indexes are different.

The determination unit 417 acquires an evaluation value “6878” from the production evaluation index information of FIG. 32. Since the evaluation value “6878” exceeds the target value “5000”, the determination unit 417 determines again that the production plan needs to be changed.

The production plan change unit 418 changes the production plan until the determination unit 417 determines that the production plan information does not need to be changed.

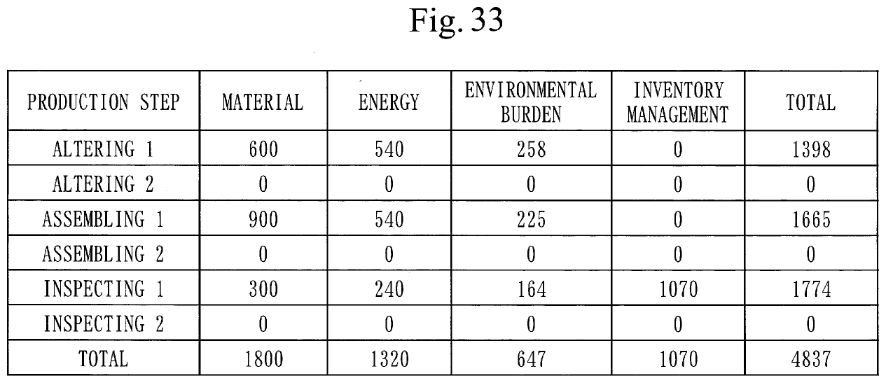

FIG. 33 illustrates the production evaluation index information acquired based on the changed production plan information illustrated in FIG. 31. The production evaluation index information of FIG. 33 has the same configuration as the production evaluation index information of FIG. 26, however, the production evaluation indexes are different.

The determination unit 417 acquires an evaluation value “4837” from the production evaluation index information of FIG. 33. Since the evaluation value “4837” is lower than the target value “5000”, the determination unit 417 determines that the production plan does not need to be changed.

*** Description of Operation ***

Next, a flow of the production plan generation process according to the present embodiment will be described.

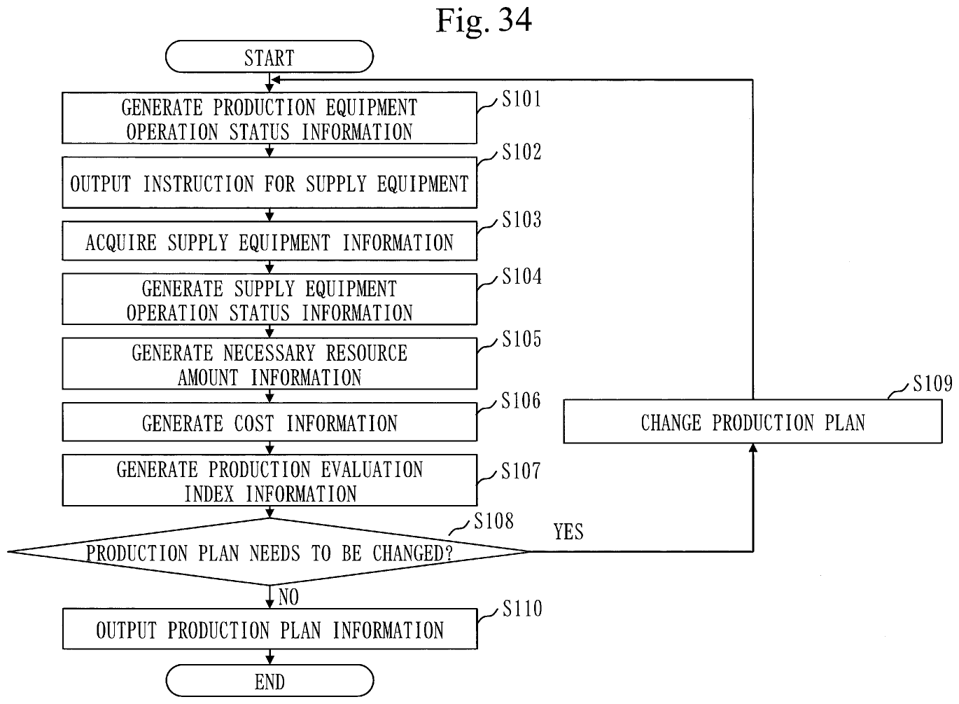

FIG. 34 is a flowchart illustrating an example of the flow of the production plan generation process according to the present embodiment.

Since steps S101 to S107 are the same as those illustrated in FIG. 27, the descriptions will be omitted.

In step S108, the determination unit 417 determines whether or not the production plan needs to be changed.

When the production plan does not need to be changed (NO), the process proceeds to step S110. On the other hand, if the production plan needs to be changed (YES), the process proceeds to step S109.

In step S109, the production plan change unit 418 changes the production plan information, and stores in the production calculation database 431, the changed production plan information. After that, the process of step S101 and the processes after step S101 are performed.

Until the determination unit 417 determines in step S108 that the production plan information does not need to be changed, the production plan change unit 418 performs the change of the production plan information in a brute-force manner.

In step S110, the communication control unit 412 outputs to the production control device 2 and the display device 5, the production plan information that the determination unit 417 determines does not need to be changed.

*** Description of Effect of Embodiment ***

As described above, according to the present embodiment, it is possible to acquire the optimized production plan since whether or not the production plan needs to be changed is determined, and when the production plan needs to be changed, the production plan is changed.

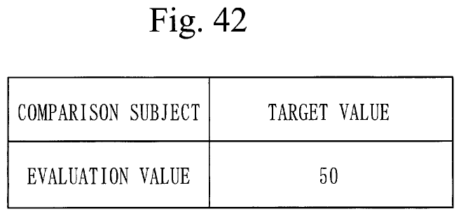

Note that, FIG. 42 illustrates an example of the production evaluation index target information according to the second embodiment when the evaluation index calculation equations defined in the equations 2a to 5a described in the first embodiment are used. The production evaluation index target information is stored in the production index target database 435. As illustrated in FIG. 42, the production evaluation index target information is configured with a comparison subject and a target value. In a column of the comparison subject, a value which is compared with the target value is indicated. The target value indicates a target value of the value indicated in the column of the comparison subject.

FIG. 29 is an example of the production evaluation index target information according to the second embodiment when the evaluation index calculation equations defined in the equations 2 to 6 described in the first embodiment are used.

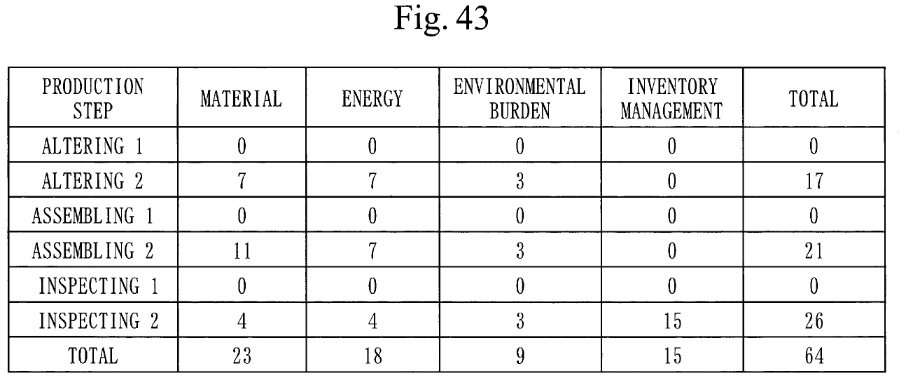

FIG. 43 illustrates the production evaluation index information acquired based on the changed production plan information illustrated in FIG. 30. The production evaluation index information of FIG. 43 has the same configuration as the production evaluation index information of FIG. 41, however, has different production evaluation indexes.

The determination unit 417 acquires an evaluation value “64” from the production evaluation index information of FIG. 43. Since the evaluation value “64” exceeds the target value “50”, the determination unit 417 determines that the production plan needs to be changed again.

Note that, FIG. 32 is an example of the production evaluation index information acquired based on the changed production plan information illustrated in FIG. 30 when the evaluation index calculation equations defined in the equations 2 to 6 described in the first embodiment are used.

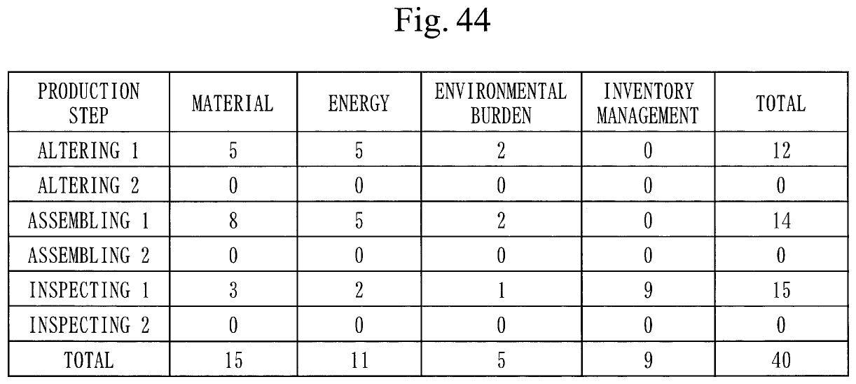

FIG. 44 illustrates the production evaluation index information acquired based on the changed production plan information illustrated in FIG. 31. The production evaluation index information of FIG. 44 has the same configuration as the production evaluation index information of FIG. 41, however, has different production evaluation indexes.

The determination unit 417 acquires an evaluation value “40” from the production evaluation index information of FIG. 44. Since the evaluation value “40” is lower than a target value “50”, the determination unit 417 determines that the production plan does not need to be changed.

Note that, FIG. 33 is an example of the production evaluation index information acquired based on the changed production plan information illustrated in FIG. 31 when the evaluation index calculation equations defined in the equations 2 to 6 described in the first embodiment are used.

### Third Embodiment

In the second embodiment, an example has been described in which the production plan change unit 418 changes the production plan information in the brute-force manner based on the determination result by the determination unit 417.

In the present embodiment, an example will be described in which a relation between the production plan changed by the production plan change unit 418 and the determination result by the determination unit 417 is learnt and based on the learning result, a production plan model which is a guide for changing the production plan is generated.

In the present embodiment, mainly matters different from the second embodiment will be described.

Note that, matters not described below are the same as those in the second embodiment.

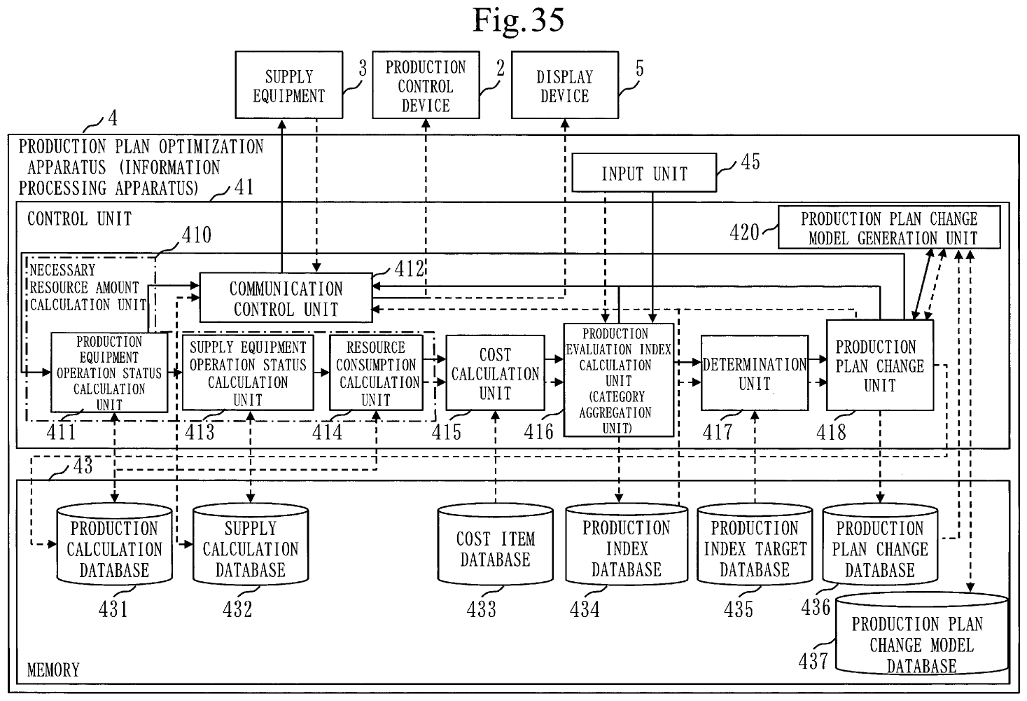

FIG. 35 illustrates a functional configuration example of the production plan optimization apparatus 4 according to the present embodiment.

Compared with FIG. 28, in FIG. 35, a production plan change model generation unit 420, the production plan change database 436, and a production plan change model database 437 are added.

Elements other than the production plan change model generation unit 420, the production plan change database 436, and the production plan change model database 437 are the same as those illustrated in FIG. 28.

The production plan change model generation unit 420 is included in the production plan generation program 421 as with the production equipment operation status calculation unit 411 and the like.

The production plan change database 436 stores the production plan information changed by the production plan change unit 418 and the determination result by the determination unit 417, which corresponds to the production plan information, in association with each other.

Below, the production plan information and the determination result which are associated with each other are collectively referred to as production plan change log information.

The production plan change model generation unit 420 acquires the production plan change log information from the production plan change database 436. Then, the production plan change model generation unit 420 performs machine learning such as reinforcement learning, using the acquired production plan change log information, and generates the production plan change model. The production plan change model is a model which is a guide for changing the production plan by the production plan change unit 418. The production plan change model generation unit 420 stores the generated production plan change model in the production plan change model database 437 of the memory 43.

Note that, the production plan change model generation unit 420 may update the production plan change model periodically. Further, the production plan change model database 437 is copied to the storage 42 periodically.

In the present embodiment, before the production plan change model is generated by the production plan change model generation unit 420, the production plan change unit 418 changes the production plan information in the brute-force manner as with the second embodiment. When the determination on the changed production plan information is performed by the determination unit 417, the production plan change unit 418 stores in the production plan change database 436, the changed production plan information and the determination result by the determination unit 417 in association with each other.

Further, after the production plan change model is generated by the production plan change model generation unit 420, the production plan change unit 418 changes the production plan information, using the production plan change model. When the determination on the changed production plan information is performed by the determination unit 417, the production plan change unit 418 stores in the production plan change database 436, the changed production plan information and the determination result by the determination unit 417 in association with each other.

Note that, above, an example has been described in which before the production plan change model is generated, the production plan change unit 418 changes the production plan information in the brute-force manner. Instead of this, the production plan change unit 418 may use an all-solutions finding method by a genetic algorithm or a Lagrangian relaxation method, and change the production plan information. By doing this, the production plan change unit 418 can generate in limited time, the production plan information whose production evaluation index is the smallest.

As described above, according to the present embodiment, it is possible to generate the proper production plan information in a short time and with a small process amount since the production plan information is changed by using the production plan change model acquired by the machine learning.

### Fourth Embodiment

In the present embodiment, an example will be described in which before the production evaluation index information (FIG. 26) is generated, the determination unit 417 determines whether or not the production plan needs to be changed.

In the present embodiment, mainly matters different from the second embodiment will described.

Note that, matters not described below are the same as those in the second embodiment.

*** Description of Configuration ***

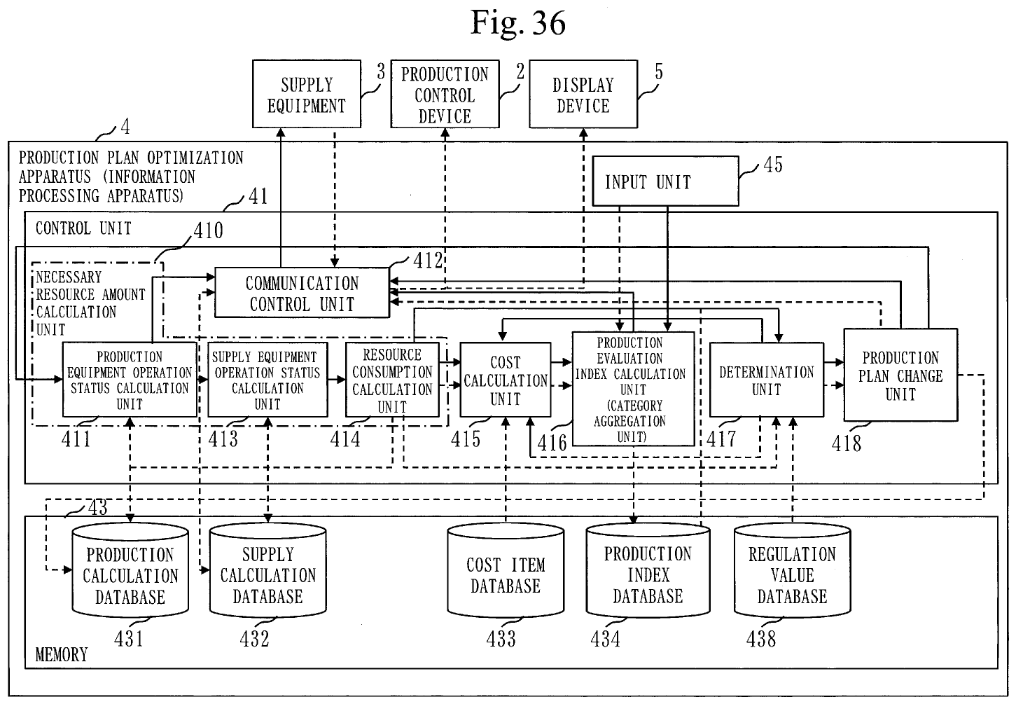

FIG. 36 illustrates a functional configuration example of the production plan optimization apparatus 4 according to the present embodiment.

Compared with FIG. 28, in FIG. 36, a regulation value database 438 is added.

Elements other than the regulation value database 438 are the same as those illustrated in FIG. 28.

The regulation value database 438 stores regulation value information. The regulation value information indicates a regulation value for the resource used for realizing the production plan, and a regulation value for the environmental burden substance generated in the production according to the production plan.

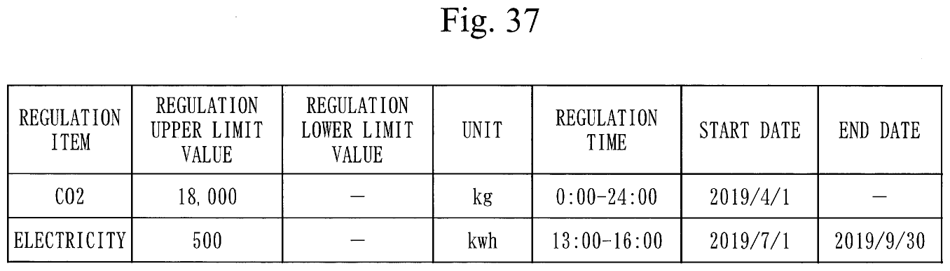

FIG. 37 indicates an example of the regulation value information.

As illustrated in FIG. 37, the regulation value information is constituted by a regulation item, a regulation upper limit value, a regulation lower limit value, a unit, regulation time, a start date, and a finish date.

In a column of the regulation item, a resource and an environmental burden substance which are subject to regulation using the regulation value information are indicated. In an example of FIG. 37, “CO2” is indicated as the environment burden substance subject to the regulation. Further, “electricity” is indicated as the resource subject to the regulation.

In columns of the regulation upper limit value and the regulation lower limit value, the regulation values for the resource and the environmental burden substance which are indicated in the columns of the regulation item are indicated.

In a column of the unit, a unit of the regulation value is indicated.

In a column of the regulation time, a time range which is subject to the regulation using the regulation value information is indicated. That is, the resource and the environmental burden substance in the production step implemented in the time range indicated in the column of the regulation time are subject to the regulation.

In a column of the start date, a date to start the regulation using the regulation value information is indicated.

In a column of the finish date, a date to finish the regulation using the regulation value information is indicated.

In the present embodiment, after the necessary resource amount information (FIG. 23) is generated, the resource consumption calculation unit 414 outputs the generated necessary resource amount information to the determination unit 417.

The determination unit 417 compares the necessary resource amount information with the regulation value information (FIG. 37).

That is, the determination unit 417 compares with the regulation value, a value of the necessary resource amount of resource subject to the regulation or a value of the environmental burden substance subject to the regulation, both of which are indicated in the necessary resource amount information.

When the value of the necessary resource amount of resources subject to the regulation or the value of the environmental burden substance subject to the regulation does not satisfy the regulation value, the determination unit 417 determines that the production plan needs to be changed.

When the determination unit 417 determines that the production plan needs to be changed, the determination unit 417 instructs the production plan change unit 418 to change the production plan.

On the other hand, when the value of the necessary resource amount of resources subject to the regulation or the value of the environmental burden substance subject to the regulation satisfies the regulation value, the determination unit 417 determines that the production plan does not need to be changed.

When the determination unit 417 determines that the production plan does not need to be changed, the determination unit 417 outputs the necessary resource amount information (FIG. 23) to the cost calculation unit 415. The process of the cost calculation unit 415 and the processes after the cost calculation unit 415 are as described in the first embodiment.

For example, a case will be considered where the determination unit 417 compares the necessary resource amount information of FIG. 23 with the regulation value information of FIG. 37.

The necessary resource amount information of FIG. 23 is generated based on the production plan information of FIG. 9.

A time period to perform the regulation using the regulation value information is “2019/4/1 to 2019/9/30”, which is derived from the start date and the finish date in the regulation value information. Since the production plan information of FIG. 9 is about “2019/9/1”, the determination unit 417 determines whether or not the production plan needs to be changed, using the regulation value information.

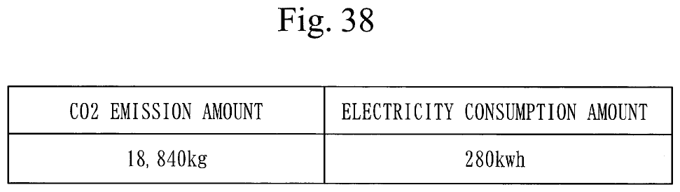

The regulation time for the “CO2” is “00:00 to 24:00”. Further, the regulation time for the “electricity” is “13:00 to 16:00”. In the production plan information of FIG. 9, a value of the “CO2” generated in the production step implemented during “00:00 to 24:00” and a value of the “electricity” required in the production step implemented during “13:00 to 16:00” are as indicated in FIG. 38.

As illustrated in FIG. 38, in the production plan information of FIG. 9, an electricity consumption amount is lower than the regulation upper limit value in the “electricity”, however, a CO2 emission amount exceeds the regulation upper limit value in the “CO2”. For this reason, regarding the production plan information of FIG. 9, the determination unit 417 determines that the production plan needs to be changed.

After the change of the production plan is instructed by the determination unit 417, the production plan change unit 418 changes the production plan as with the second embodiment. The production plan change unit 418 changes the production plan until the determination unit 417 determines that the production plan does not need to be changed.

Every time the production plan is changed by the production plan change unit 418, the production equipment operation status calculation unit 411, the supply equipment operation status calculation unit 413, and the resource consumption calculation unit 414 perform the same processes as those in the first embodiment.

That is, the production equipment operation status calculation unit 411 specifies based on the changed production plan, the resources required in the production equipment 1 for realizing the changed production plan (generates the production equipment operation status information (FIG. 19)).

Further, the supply equipment operation status calculation unit 413 specifies based on the changed production plan, the resources required in the supply equipment 3 for realizing the changed production plan (generates the supply equipment operation status information (FIG. 22)).

Further, the resource consumption calculation unit 414 calculates as the necessary resource amount, the amount of each resource necessary for realizing the changed production plan (generates the necessary resource amount information (FIG. 23)).

*** Description of Operation***

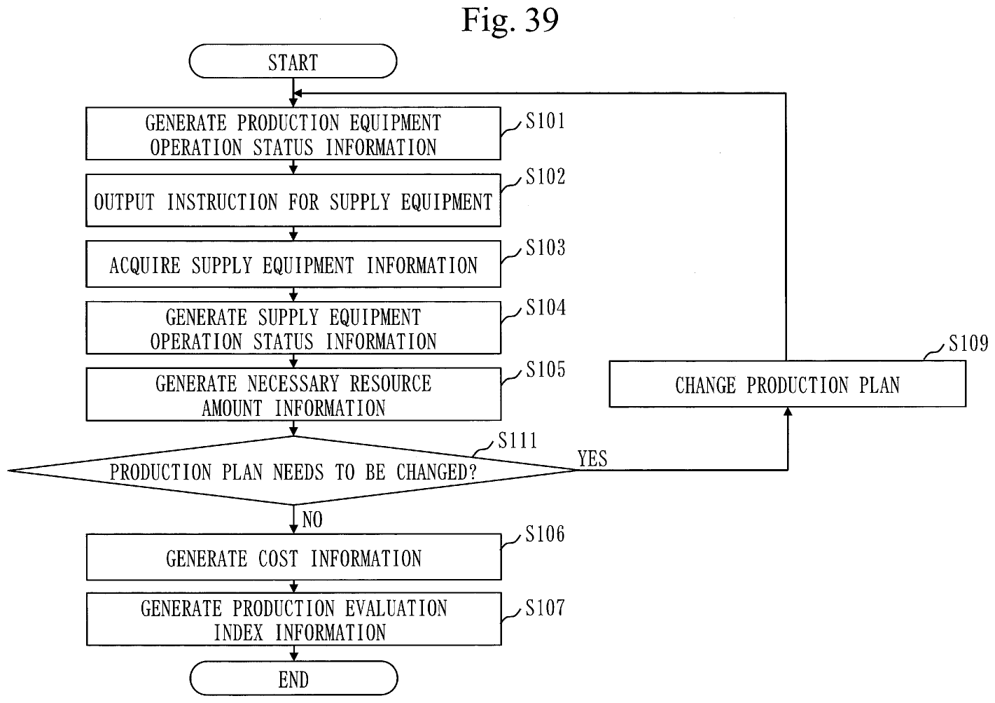

FIG. 39 is a flowchart illustrating an example of a flow of the production plan generation process according to the present embodiment.

Since steps S101 to S105 are the same as those illustrated in FIG. 27, the descriptions will be omitted.

After the necessary resource amount information (FIG. 23) is generated in step S105, in step S111, the determination unit 417 compares the necessary resource amount information with the regulation value information, and determines whether or not the production plan needs to be changed.

When the production plan does not need to be changed (NO), the process proceeds to step S106. On the other hand, when the production plan needs to be changed (YES), the process proceeds to step S109.

Since steps S106 and S107 are the same as those illustrated in FIG. 27, the descriptions will be omitted.

Further, since step S109 is the same as that illustrated in FIG. 34, the descriptions will be omitted.

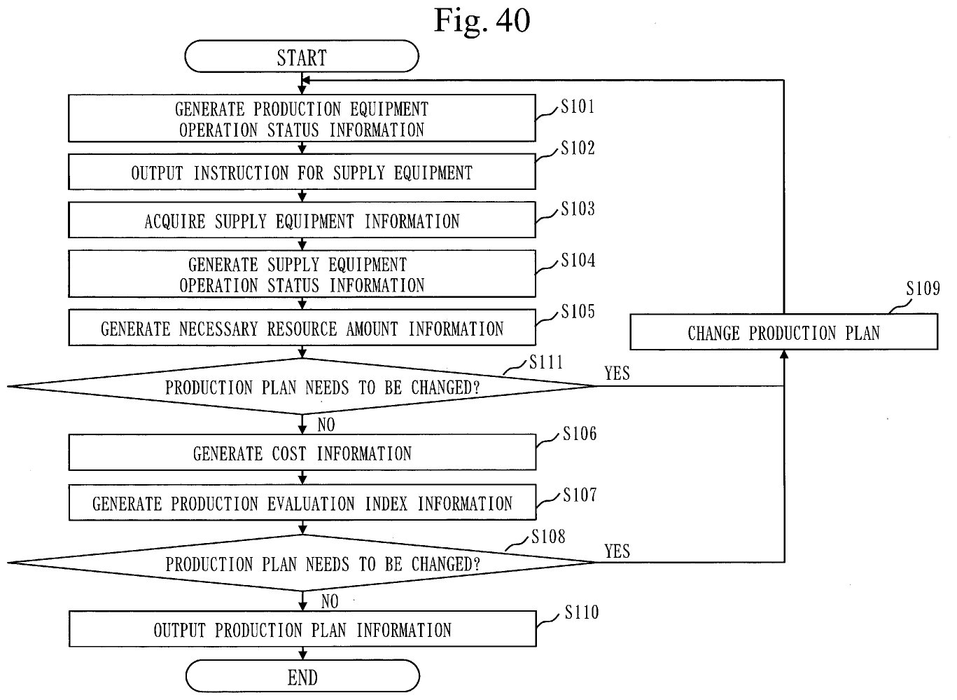

Further, as illustrated in FIG. 40, after step S111, as with the second embodiment, the determination unit 417 may compare the production evaluation index information (FIG. 26) with the production evaluation index target information (FIG. 29), and determine whether or not the production plan needs to be changed (step S108).

*** Description of Effect of Embodiment ***

In the present embodiment, it is possible to acquire the optimized production plan since when the value of the resource or the environmental burden substance does not satisfy the regulation value, the production plan is changed.

Although the embodiments of the present invention have been described above, two or more of these embodiments may be combined and implemented.

Alternatively, one of these embodiments may be partially implemented.

Alternatively, two or more of these embodiments may be partially combined and implemented.

Note that, the present invention is not limited to these embodiments, and various modifications can be made as necessary.

*** Supplementary Description ***

Finally, supplementary descriptions to a configuration of the production plan optimization apparatus 4 will be described.

When the control unit 41 is the processor, an OS (Operating System) is also stored in the storage 42.

Then, at least a part of the OS is executed by the control unit 41 which is the processor.

While executing at least the part of the OS, the control unit 41 executes the production plan generation program 421.

By the control unit 41 executing the OS, task management, memory management, file management, communication control, and the like are performed.

Further, the production plan generation program 421 may be stored in a portable recording medium such as a magnetic disk, a flexible disk, an optical disc, a compact disc, a Blu-ray (registered trademark) disc, or a DVD. Further, the portable recording medium storing the production plan generation program 421 may be distributed.

Further, “unit” of the necessary resource amount calculation unit 410, the production equipment operation status calculation unit 411, the communication control unit 412, the supply equipment operation status calculation unit 413, the resource consumption calculation unit 414, the cost calculation unit 415, the production evaluation index calculation unit 416, the determination unit 417, and the production plan change unit 418 may be read as “circuit”, “step”, “procedure”, or “process”.

### REFERENCE SIGNS LIST

1: production equipment, 2: production control device, 3: supply equipment, 4: production plan optimization apparatus, 5: display device, 6: network, 41: control unit, 42: storage, 43: memory, 44: communication unit, 45: input unit, 100: production plan optimization system, 410: necessary resource amount calculation unit, 411: production equipment operation status calculation unit, 412: communication control unit, 413: supply equipment operation status calculation unit, 414: resource consumption calculation unit, 415: cost calculation unit, 416: production evaluation index calculation unit, 417: determination unit, 418: production plan change unit, 420: production plan change model generation unit, 421: production plan generation program, 431: production calculation database, 432: supply calculation database, 433: cost item database, 434: production index database, 435: production index target database, 436: production plan change database, 437: production plan change model database, 438: regulation value database.

1. An information processing apparatus comprising:
processing circuitry
to specify based on a production plan which includes a plurality of production steps, for each production step, a resource necessary for realizing each production step, and calculate as a necessary resource amount, for each production step, an amount of specified resource necessary for realizing the production plan;
to calculate for each production step, a cost for acquiring the necessary resource amount of the resource specified; and
to assign for each production step according to a purpose of the resource specified, the resource specified to a purpose category among a plurality of purpose categories each of which is a category of a purpose, and aggregate the cost of the resource for each production step and each purpose category.

2. The information processing apparatus according to claim 1, wherein
the processing circuitry indexes aggregation results of the costs of the plurality of purpose categories of the plurality of production steps.

3. The information processing apparatus according to claim 2, wherein
the processing circuitry calculates an evaluation value of the production plan, using an index value of an aggregation result of the cost of each purpose category acquired by indexing, and a weight coefficient of each purpose category.

4. The information processing apparatus according to claim 1, wherein
the processing circuitry
determines whether or not the production plan needs to be changed, and
changes the production plan when it is determined that the production plan needs to be changed.

5. The information processing apparatus according to claim 4, wherein
the processing circuitry
specifies based on a changed production plan, a plurality of resources used for realizing the changed production plan, and calculates as a necessary resource amount, an amount of each resource necessary for realizing the changed production plan,
calculates for each resource specified based on the changed production plan, a cost for acquiring the necessary resource amount, and
assigns according to a purpose of each resource specified based on the changed production plan, each resource to a purpose category, and aggregates for each purpose category, the cost of the resource assigned to each purpose category.

6. The information processing apparatus according to claim 4, wherein
the processing circuitry
calculates an evaluation value of the production plan, using an index value of an aggregation result of the cost of each purpose category acquired by indexing, and a weight coefficient of each purpose category, and
compares the evaluation value with a target value for the evaluation value, and determines whether or not the production plan needs to be changed.

7. The information processing apparatus according to claim 4, wherein
the processing circuitry compares the necessary resource amount of a resource among the plurality of resources used for realizing the production plan, with a regulation value of the resource, and determines whether or not the production plan needs to be changed.

8. The information processing apparatus according to claim 4, wherein
the processing circuitry compares a value of an environmental burden occurred in production according to the production plan with a regulation value of the environmental burden, and determines whether or not the production plan needs to be changed.

9. The information processing apparatus according to claim 4, wherein
the processing circuitry
generates a production plan change model which is a guide for changing a production plan, and
changes the production plan, using the production plan change model, when it is determined that the production plan needs to be changed.

10. An information processing apparatus comprising:
processing circuitry
to specify based on a production plan, as a plurality of resources used for realizing the production plan, a consumption resource which is a resource consumed in production, an environmental burden reduction resource which is a resource used for reducing an environmental burden occurred in the production, and an inventory management resource which is a resource used for inventory management, and calculate as a necessary resource amount, for each of the consumption resource, the environmental burden reduction resource, and the inventory management resource, an amount of resource necessary for realizing the production plan;
to calculate a cost for acquiring the necessary resource amount of each of the consumption resource, the environmental burden reduction resource, and the inventory management resource; and
to assign according to a purpose of each resource, each of the consumption resource, the environmental burden reduction resource, and the inventory management resource to a purpose category among a plurality of purpose categories each of which is a category of a purpose, and aggregate for each purpose category, the cost of the resource assigned to each purpose category.

11. The information processing apparatus according to claim 10, wherein
the processing circuitry
specifies as one of the plurality of resources used for realizing the production plan, a supply equipment resource which is a resource consumed for supplying the consumption resource in supply equipment which supplies the consumption resource, and
calculates the necessary resource amount of the supply equipment resources.

12. An information processing method comprising:
specifying based on a production plan which includes a plurality of production steps, for each production step, a resource necessary for realizing each production step, and calculating as a necessary resource amount, for each production step, an amount of specified resource necessary for realizing the production plan;
calculating for each production step, a cost for acquiring the necessary resource amount of the resource specified; and
assigning for each production step according to a purpose of the resource specified, the resource specified to a purpose category among a plurality of purpose categories each of which is a category of a purpose, and aggregating the cost of the resource for each production step and each purpose category.

13. A non-transitory computer readable medium storing an information processing program which causes a computer to execute:
a necessary resource amount calculation process of specifying based on a production plan which includes a plurality of production steps, for each production step, a resource necessary for realizing each production step, and calculating as a necessary resource amount, for each production step, an amount of specified resource necessary for realizing the production plan;
a cost calculation process of calculating for each production step, a cost for acquiring the necessary resource amount of the resource specified by the necessary resource amount calculation process; and
a category aggregation process of assigning for each production step according to a purpose of the resource specified by the necessary resource amount calculation process, the resource specified by the necessary resource amount calculation process to a purpose category among a plurality of purpose categories each of which is a category of a purpose, and aggregating the cost of the resource for each production step and each purpose category.

14. The information processing apparatus according to claim 2, wherein
the processing circuitry performs for each purpose category, one of dividing a multiplication value of cost and load time by a value of a production quantity, and dividing a multiplication value of the cost and load time by a squared value of the production quantity, and indexes aggregation results of the costs of the plurality of purpose categories.

15. An information processing method comprising:
specifying based on a production plan, as a plurality of resources used for realizing the production plan, a consumption resource which is a resource consumed in production, an environmental burden reduction resource which is a resource used for reducing an environmental burden occurred in the production, and an inventory management resource which is a resource used for inventory management, and calculating as a necessary resource amount, for each of the consumption resource, the environmental burden reduction resource, and the inventory management resource, an amount of resource necessary for realizing the production plan;
calculating a cost for acquiring the necessary resource amount of each of the consumption resource, the environmental burden reduction resource, and the inventory management resource; and
assigning according to a purpose of each resource, each of the consumption resource, the environmental burden reduction resource, and the inventory management resource to a purpose category among a plurality of purpose categories each of which is a category of a purpose, and aggregating for each purpose category, the cost of the resource assigned to each purpose category.

16. A non-transitory computer readable medium storing an information processing program which causes a computer to execute:
a necessary resource amount calculation process of specifying based on a production plan, as a plurality of resources used for realizing the production plan, a consumption resource which is a resource consumed in production, an environmental burden reduction resource which is a resource used for reducing an environmental burden occurred in the production, and an inventory management resource which is a resource used for inventory management, and calculating as a necessary resource amount, for each of the consumption resource, the environmental burden reduction resource, and the inventory management resource, an amount of resource necessary for realizing the production plan;
a cost calculation process of calculating a cost for acquiring the necessary resource amount of each of the consumption resource, the environmental burden reduction resource, and the inventory management resource; and
a category aggregation process of assigning according to a purpose of each resource, each of the consumption resource, the environmental burden reduction resource, and the inventory management resource to a purpose category among a plurality of purpose categories each of which is a category of a purpose, and aggregating for each purpose category, the cost of the resource assigned to each purpose category.
